(19) United States
(12) Patent Application Publication
(10) Pub. No.: US 2014/0003294 A1
(43) Pub. Date: Jan. 2, 2014

(54) CONFIGURATION DIAGRAM PREPARING APPARATUS, AND COMPUTER-READABLE RECORDING MEDIUM HAVING STORED THEREIN CONFIGURATION DIAGRAM PREPARING PROGRAM

(71) Applicant: FUJITSU LIMITED, Kawasaki-shi (JP)

(72) Inventors: Takashi KOMATSU, Kawasaki (JP); Kazuya NAGAI, Kawasaki (JP)

(73) Assignee: FUJITSU LIMITED, Kawasaki-shi (JP)

(21) Appl. No.: 13/923,090

(22) Filed: Jun. 20, 2013

Related U.S. Application Data
(63) Continuation of application No. PCT/JP2010/073123, filed on Dec. 22, 2010.

(51) Int. Cl. H04L 12/24

(52) U.S. Cl. CPC H04L 41/0823
USPC 370/255

(57) ABSTRACT

A judgment unit judges which one of an intermediate node and a terminal node each node depicted in a network configuration diagram as a node image is, based on node information. A first placement unit places, in the configuration diagram, an intermediate node image of a node judged as the intermediate node in a tree form having a first direction in which the intermediate node image of the same layer is placed and a second direction indicating a depth direction of a layer of the intermediate node, based on the node information. A second placement unit places a terminal node image of a node judged as a terminal node at a position of the second direction from the intermediate node image placed by the first placement unit to a parent node of the terminal node.

### CROSS-REFERENCE TO RELATED APPLICATION

This application is a continuation application of International Application PCT/JP2010/073123 filed on Dec. 22, 2010 and designated the U.S., the entire contents of which are incorporated herein by reference.

### FIELD

The invention is related to a configuration diagram preparing apparatus, and a computer-readable recording medium having stored therein a configuration diagram preparing program.

### BACKGROUND

In the related art, a network configuration diagram is prepared by a human hand. The reason is that a means is not provided, which efficiently lays out, on a paper plane, a network configuration including information desired as the network configuration in printing the network configuration diagram on a paper medium, and the diagram needs to be prepared while appropriately securing a handwritable space by viewing.

Herein, when a physical network configuration diagram, in detail, a type of a layer 2 network is considered, for example, a network of Ethernet (registered trademark) is connected in a star type and has a topological tree structure. Therefore, in laying out the network configuration, the tree structure is used even in the related art and several methods of effectively and efficiently laying out the tree structure are considered.

For example, as represented as Explorer of Microsoft (registered trademark) Corporation, a display method of setting the depth of a layer to a right direction and arraying data (node) of the same layer in a longitudinal direction is generally used. A detailed display example by the display method is illustrated in FIG. 28. In FIG. 28, a rectangular block indicates a node in a physical network.

In this case, when the number of nodes of a tree increases, layout data is lengthened vertically in proportion to the number of nodes in a layout method illustrated in FIG. 28, and as a result, it is known that visibility or operability deteriorates. Therefore, a lot of techniques for improving the visibility or operability of the tree structure are proposed and the techniques are largely classified into a technique to improve visibility or operability of a specific node and a technique to improve visibility or operability of all nodes.

As the technique to improve the visibility or operability of the specific node, for example, the aforementioned Explorer of the Microsoft may be used in addition to techniques disclosed in Patent Literatures 1 and 2. Further, as the technique to improve the visibility or operability of all nodes, for example, techniques disclosed in Patent Literatures 3 to 5 may be used.
[Patent Literature 1] Japanese Laid-open Patent Publication No. 2005-242944
[Patent Literature 2] Japanese Laid-open Patent Publication No. 2007-026210
[Patent Literature 3] Japanese Laid-open Patent Publication No. 07-006014
[Patent Literature 4] Japanese Laid-open Patent Publication No. 2001-125925
[Patent Literature 5] Japanese Patent No. 3705550

As described above, in the related art in which the desired information is added by handwriting, in order to secure a space for depicting the information, a user needs to lay out the network configuration diagram with human hands, and as a result, large efforts are needed to the user. Further, since the user inputs or updates information with the human hands, errors are frequently incurred, and as a result, the reliability of printed information also deteriorates.

In recent years, achieving paperlessness is promoted as an approach of achieving business efficiency or reducing cost, but since the paper medium has the following features (1) to (3), it is difficult to consider a situation in which the paper medium completely disappears.

(1) The paper medium does not need a system for reading electronic data and has large convenience with respect to transportation.

(2) Since a lot of persons can refer to the paper medium by the magnitude of a spatial degree of freedom, the visibility of the paper medium is excellent.

(3) It is easy to depict a matter to be noted in the paper medium. An operation by paper and a pencil is apparently more excellent than a mouse operation or a touch operation in terms of operability by the user.

Therefore, even though achieving the paperlessness is promoted, effectively using the paper medium is continuously desired and effectively using a paper plane at the time of printing the matters in the paper medium is valuable even in terms of economy and the effective use of resources.

### SUMMARY

A configuration diagram preparing apparatus prepares a configuration diagram of a network having nodes including an intermediate node and a terminal node and includes a storage unit that stores node information associated with each of the nodes in the network; and a processing unit that prepares the configuration diagram based on the node information stored by the storage unit. The processing unit includes a judgment unit, a first placement unit, and a second placement unit. In addition, the judgment unit judges whether each node depicted as a node image in the configuration diagram is the intermediate node or the terminal node, based on the node information stored by the storage unit. The first placement unit places, in the configuration diagram, an intermediate node image of a node judged as the intermediate node by the judgment unit in a tree form having a first direction in which the intermediate node image of the same layer is placed and a second direction indicating a depth direction of a layer of the intermediate node, based on the node information stored by the storage unit. The second placement unit places a terminal node image of a node judged as the terminal node by the judgment unit at a position of the second direction from an intermediate node image of an upper intermediate node placed by the first placement unit and connected to an upper layer of the terminal node.

Further, a configuration diagram preparing program makes a computer prepare a configuration diagram of a network having nodes including an intermediate node and a terminal node based on node information associated with each node in the network and makes the computer function as the judgment unit, the first placement unit, and the second placement unit.

Further, a computer-readable recording medium has the configuration diagram preparing program stored therein.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating a functional configuration and a hardware configuration of a configuration diagram preparing apparatus of an embodiment.

FIG. 2 is a diagram for describing collection target network information to designate a network which a network configuration information collecting unit intends to collect according to the embodiment.

FIG. 3 is a diagram for describing network configuration information collected by the network configuration information collecting unit according to the embodiment.

FIG. 4 is a diagram for describing node information included in the network configuration information in more detail.

FIG. 5 is a diagram for describing a layout definition which a network configuration diagram preparing unit uses in preparing a configuration diagram according to the embodiment.

FIG. 6 is a diagram for describing print/display data stored in a layout completion data storing unit according to the embodiment.

FIG. 7 is a diagram illustrating a status of a preparation process of a network configuration diagram to describe placing operation by a first placement unit and a second placement unit according to the embodiment.

FIG. 8 is a diagram illustrating a status of a preparation process of a network configuration diagram to describe a parallel placement operation by the second placement unit according to the embodiment.

FIG. 9 is a diagram illustrating a status of the preparation process of the network configuration diagram to describe a size determining operation by the first placement unit and operations by a first wiring unit and a second wiring unit according to the embodiment.

FIG. 10 is a diagram illustrating a status of a preparation process of a network configuration diagram to describe operations by a first additional writing unit and a second additional writing unit according to the embodiment.

FIG. 11 is a flowchart for describing overall processing by a configuration diagram preparing apparatus according to the embodiment.

FIG. 12 is a flowchart for describing processing by the network configuration information collecting unit according to the embodiment.

FIG. 13 is a flowchart for describing processing by the network configuration diagram preparing unit according to the embodiment.

FIG. 14 is a diagram illustrating a detailed configuration example of a network of which a configuration diagram needs to be prepared.

FIG. 15 is a flowchart for describing judgment processing.

FIG. 16 is a flowchart for describing placement processing of node images.

FIG. 17 is a diagram illustrating a status of a network configuration diagram at a completion time of the processing illustrated in FIG. 16 in order to describe the processing illustrated in FIG. 16 in detail.

FIG. 18 is a flowchart for describing determination processing of a horizontal width or a horizontal width direction placement location of an intermediate node image, and wiring processing among intermediate node images and parallel placement processing of terminal node images.

FIG. 19 is a diagram illustrating a status of a network configuration diagram at a completion time of the processing illustrated in FIG. 18 in order to describe the processing illustrated in FIG. 18 in detail.

FIG. 20 is a flowchart for describing determination processing of the height or a height direction placement location of the intermediate node image, determination processing of a placement location of the terminal node image, and wiring processing of the terminal node images.

FIG. 21 is a diagram illustrating a status of a network configuration diagram at a completion time of the processing illustrated in FIG. 20 in order to describe the processing illustrated in FIG. 20 in detail.

FIG. 22 is a flowchart for describing additional writing processing of node information, or the like.

FIG. 23 is a diagram illustrating a status of a network configuration diagram at a completion time of the processing illustrated in FIG. 22 in order to describe the processing illustrated in FIG. 22 in detail.

FIG. 24 is a diagram illustrating an example of more detailed display/print data prepared by the configuration diagram preparing apparatus according to the embodiment.

FIG. 25A is a diagram illustrating a display/print example of a network configuration diagram prepared by a method which is not in accordance with the embodiment and FIG. 25B is a diagram illustrating the display/print example of the network configuration diagram prepared by the configuration diagram preparing apparatus according to the embodiment with respect to the same network as the FIG. 25A.

FIG. 26 is a diagram illustrating a first modified example of the network configuration diagram prepared by the configuration diagram preparing apparatus according to the embodiment.

FIG. 27 is a diagram illustrating a second modified example of the network configuration diagram prepared by the configuration diagram preparing apparatus according to the embodiment.

FIG. 28 is a diagram illustrating a detailed display example by a general display method of displaying a configuration diagram of a physical network.

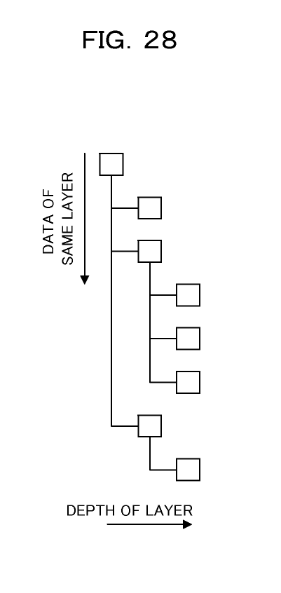

FIGS. 29A to 29C are diagrams for describing a display method which is not in accordance with the embodiment.

FIG. 30 is a diagram illustrating a display example in the case where the number of nodes on a lowermost layer is four times the number of nodes on a layer higher than the lowermost layer by one stage.

### DESCRIPTION OF EMBODIMENTS

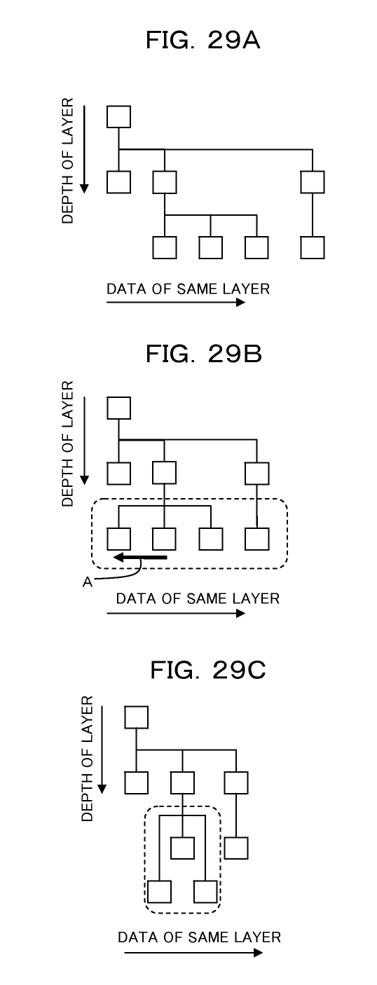

FIGS. 29A to 29C are diagrams describing a display method which are not according to an embodiment of the invention. In FIGS. 29A to 29C, a useless space generated at the time of displaying a tree structure is reduced to display all nodes in a small space. Therefore, a tree structure displayed as illustrated in FIG. 29A is displayed as illustrated in FIG. 29B or 29C. Note that, in FIGS. 29A to 29C, a rectangular block indicates a node in a physical network.

In FIG. 29A, basically, the depth of a layer is set in a longitudinal direction and nodes of the same layer are arrayed and displayed in a right direction. In this regard, in FIG. 29B, in the case where the nodes of the same layer are placed, when the nodes may be placed in a direction (the direction of arrow A in a dotted-line periphery) which is opposite to a general placement direction (right direction), the nodes are placed even in a reverse direction to make a display space to be small. Further, in FIG. 29C, the nodes of the same layer are displayed more densely by alternately placing terminal layers in a vertical direction as illustrated in the dotted-line periphery with respect to the display of FIG. 29B to increase the number of the nodes displayed on the same layer.

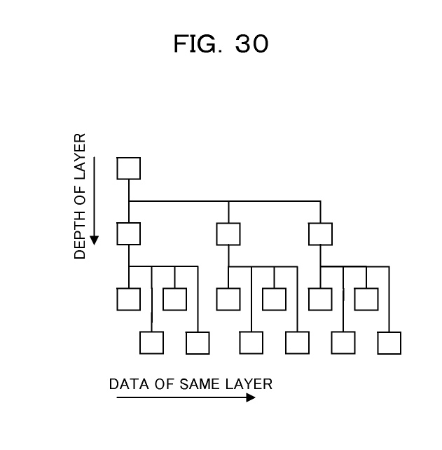

However, in the example of FIGS. 29A to 29C, in the case where the number of nodes on a lowermost layer is two times more than the number of nodes on a layer higher than the lowermost layer by one stage, as illustrated in FIG. 30, a display width of all of the nodes on the lowermost layer, that is, a horizontal width may be only reduced to a half to the maximum as compared with the display of FIG. 29A. FIG. 30 illustrates a display example in the case where the number of nodes on the lowermost layer is four times more than the number of nodes on the layer higher than the lowermost layer by one stage.

When a tree structure which is laid out is printed in the paper medium as illustrated in FIG. 30, in the case where a horizontal to vertical ratio of the tree structure and a longitudinal ratio of the paper medium do not coincide with each other, the size of each node needs to be smaller than is desired in order to house the tree structure in one paper plane. As such, there is a case in which large waste occurs on a paper plane on which the tree structure is printed by adjusting the size of the node.

Further, when printing or displaying is performed in a connection form between ports or a type to add physical positional information (port number) of each port, which is used to prepare the network configuration diagram, the efficiency of the printing or displaying remarkably deteriorates. For example, in a network configuration, an intermediate node becomes a component such as a switching hub and considerably many terminal nodes, for example, personal computers (PCs) are connected to each intermediate node. There are less cases in which only one PC is connected to one switching hub and 10 PCs, in some cases, more PCs are generally connected to the switching hub.

As a result, it is difficult to suppress a display length in a single direction, for example, a lateral direction by a layout method for adding port information to each intermediate node or shifting a placement location of the terminal node as illustrated in FIG. 29B. Therefore, even though the tree structure which is laid out is printed in the paper medium, a suppressing effect of a print length in the single direction may not be so acquired and rather, a possibility of enlarging a useless space on the paper plane is higher.

That is, in order to implement an efficient layout to print the network configuration diagram on the paper plane, it is requested to efficiently lay out a connection relationship between the ports in the intermediate node or perform the layout by considering that the terminal nodes are more than the intermediate nodes.

In the layout of the configuration diagram illustrated in FIG. 30, or the like, the largest cause for requiring a broad space in the lateral direction or the longitudinal direction is that, for example, the tree structure is lengthened in the direction of “the data of the same layer”, as illustrated in FIG. 30, in the case where the number of terminal nodes increases.

In the embodiment, by considering a feature of the physical network that the terminal nodes are much more than the intermediate nodes, the intermediate nodes are distinguished from the terminal nodes, and the intermediate nodes and the terminal nodes are placed by respectively different methods. As a result, as described below, it is possible to decrease the length in the direction of “the data of the same layer” of the configuration diagram.

Herein, the intermediate node is, for example, a router or the switching hub and other intermediate nodes or terminal nodes are connected to a lower layer thereof. The terminal nodes are, for example, a PC, a server, and a network printer and any node is not connected to a lower layer thereof.

Hereinafter, embodiments will be described with reference to the accompanying drawings.

[1] Configuration of Configuration Diagram Preparing Apparatus

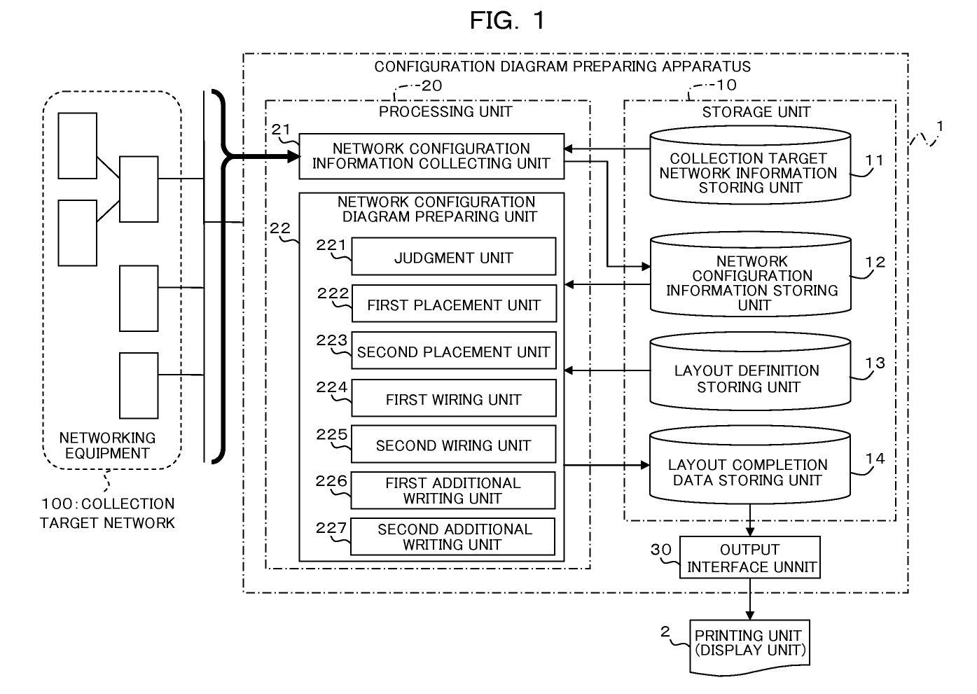

FIG. 1 is a block diagram illustrating a functional configuration and a hardware configuration of a configuration diagram preparing apparatus of an embodiment. A configuration diagram preparing apparatus 1 illustrated in FIG. 1 prepares a configuration diagram of a physical network including intermediate nodes and terminal nodes. The configuration diagram preparing apparatus 1 is configured by a calculator of a general PC, or the like and includes a storage unit 10, a processing unit 20, and an output interface unit 30 and further includes a man-machine interface (not illustrated) which is operated by a user to input various pieces of information in the configuration diagram preparing apparatus 1. Note that, the processing unit 20 is a central processing unit (CPU), or the like. In addition, the storage unit 10 may be an internal storage device such as a random access memory (RAM), a read only memory (ROM), a hard disk drive (HDD), a solid state disk (SSD), or the like and may be an external storage device.

The storage unit 10 includes a collection target network information storing unit 11, a network configuration information storing unit 12, a layout definition storing unit 13, and a layout completion data storing unit 14 in addition to storing the configuration preparing program for implementing various functions of the configuration diagram preparing apparatus 1.

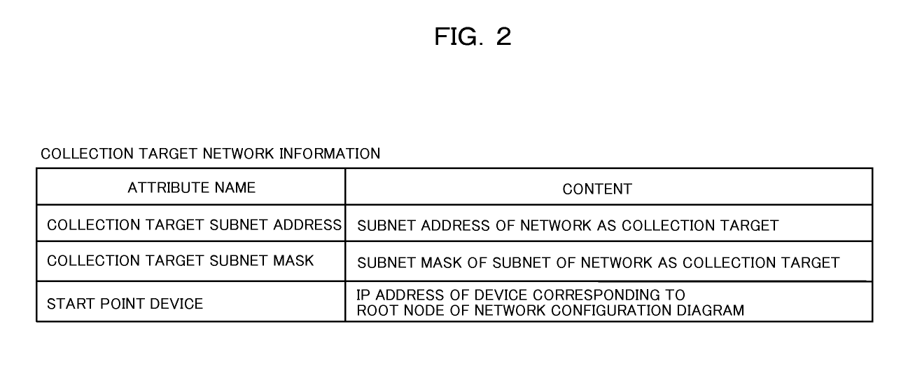

The collection target network information storing unit 11, in advance, stores collection target network information to designate a collection target network 100 from which network configuration information is to be collected by a network configuration information collecting unit 21 to be described below. The collection target network information includes, for example, a “collection target subnet address”, a “collection target subnet mask”, and a “start point device”, as illustrated in FIG. 2. Note that, FIG. 2 is a diagram for describing collection target network information in which the network configuration information collecting unit 21 designates a network to be collected.

The “collection target subnet address” is a subnet address of the network 100 to be collected by the network configuration information collecting unit 21.

The “collection target subnet mask” is a subnet mask of the network 100 to be collected by the network configuration information collecting unit 21.

The “start point device” is an Internet Protocol (IP) address of a device corresponding to a root node of a network configuration diagram to be prepared, that is, an uppermost node of a tree structure.

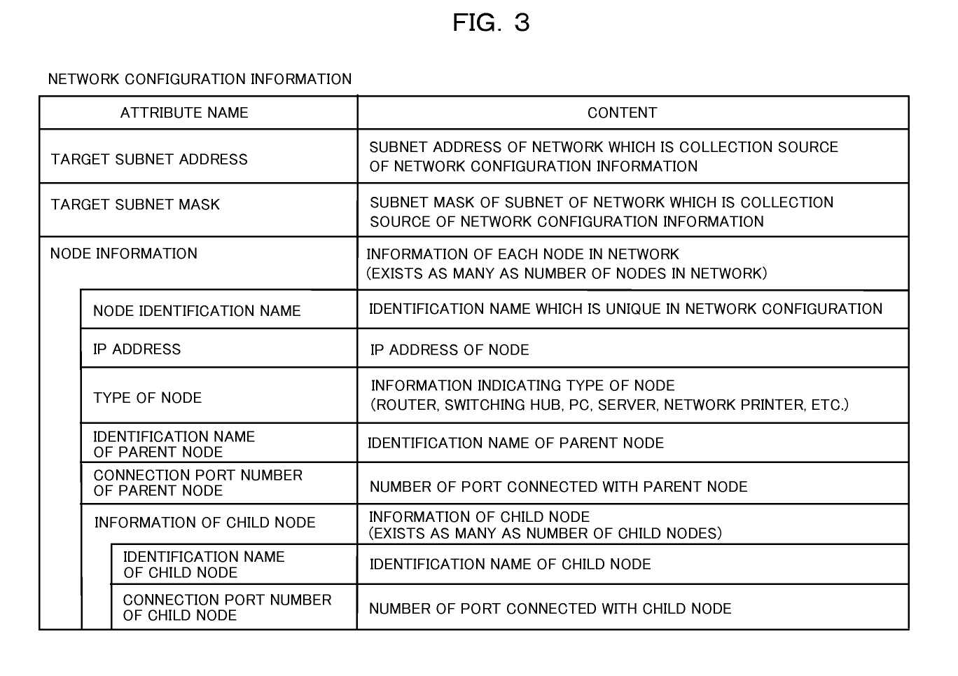

The network configuration information storing unit 12 stores the network configuration information collected from the collection target network 100 by the network configuration information collecting unit 21 to be described below. The network configuration information includes, for example, a “target subnet address”, a “target subnet mask”, and “node information”, as illustrated in FIG. 3. Note that, FIG. 3 is a diagram for describing the network configuration information collected by the network configuration information collecting unit 21.

The “target subnet address” is a subnet address of the network 100 which is a collection source of the network configuration information.

The “target subnet mask” is a subnet mask of the network 100 which is the collection source of the network configuration information.

The “node information” is node information related to an intermediate node or a terminal node which is a networking equipment constituting the collection target network 100 and includes a “node identification name”, an “IP address”, a “node type”, an “identification name of a parent node”, and a “connection port number of the parent node” of a target node, for each networking equipment, that is, for each node. Further, the “node information” includes “information on a child node” in the case where the child node is connected to a lower layer of the target node.

The “node identification name” is a unique identification name in the network configuration, in advance, given to the target node in order to specify the target node.

The “IP address” is an IP address of the target node.

The “node type” is information indicating a type of the target node, that is, information indicating which one of a router, a switching hub, a PC, a server, a network printer, and the like the target node is.

The “identification name of the parent node” is a node identification name capable of specifying a node connected to an upper layer of the target node, that is, the parent node.

The “connection port number of the parent node” is a connection port number capable of specifying a port connected with the parent node in the target node.

The “information on the child node” is node information on the child node connected to the lower layer of the target node and includes an “identification name of the child node” and a “connection port number of the child node” for each child node.

The “identification name of the child node” is a node identification name capable of specifying a node connected to the lower layer of the target node, that is, the child node.

The “connection port number of the child node” is a connection port number capable of specifying a port connected with the child node in the target node.

Note that, in the case where the target node is the start point device (root node), the information on the parent node, that is, the “identification name of the parent node” and the “connection port number of the parent node” are not included in the “node information”.

Further, in the case where the target node is the intermediate node to which the child node is not connected to the lower layer or in the case where the target node is the terminal node, the “information on the child node”, that is, the “identification name of the child node” and the “connection port number of the child node” are not included in the “node information”.

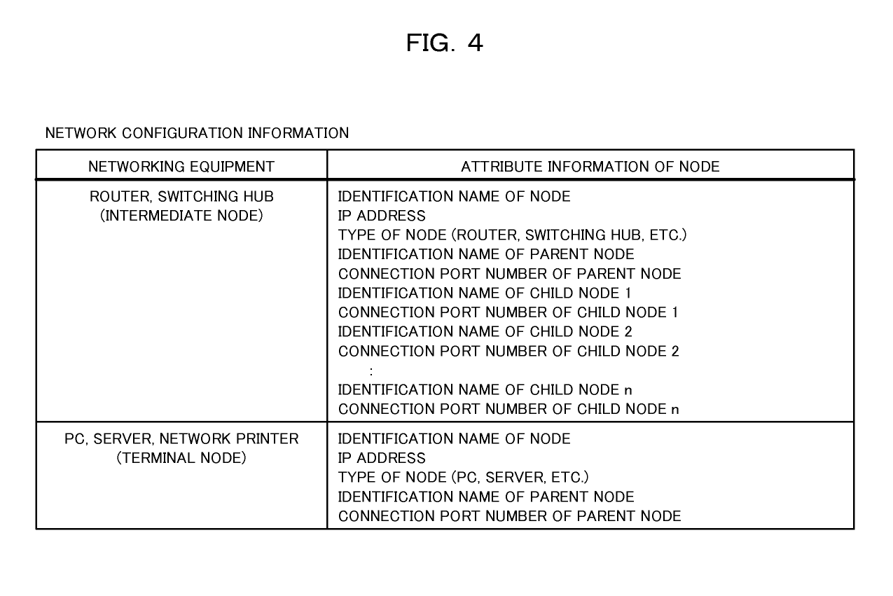

Herein, the “node information” collected as the “network configuration information” and stored in the storing unit 12 will be described in more detail with reference to FIG. 4. Note that, FIG. 4 is a diagram for describing the node information included in the network configuration information in more detail.

In FIG. 4, in two cases where the target node is the networking equipment such as the router, or the switching hub and where the target node is the networking equipment such as the PC, the server, or the network printer, attribution information of each node, that is, the “node information” is illustrated.

In the case where the target node is the router, the switching hub, or the like, another node, that is, the child node may be connected to the lower layer of the target node and the target node is referred to as the “intermediate node”. In the case where the target node is the intermediate node, the information on the parent node and the child node is included in the node information in addition to the identification name, the IP address, and the type (the information indicating which one of the router, the switching hub, and the like the target node is) of the target node, as illustrated in an upper end of FIG. 4. FIG. 4 illustrates attribute information in the case where n child nodes 1, 2, . . . , n (n is a natural number) are connected to the lower layer of the target node. The information on the parent node includes the “identification name of the parent node” and the “connection port number of the parent node” which are described above with reference to FIG. 3. Information on each child node i (i=1, 2, . . . , n) includes the “identification name of the child node” and a “connection port number of a child node i” which are described above with reference to FIG. 3.

In the case where the target node is the PC, the server, the network printer, or the like, since there is no case where another node is connected to the lower layer of the target node, the target node is referred to as the “terminal node”. In the case where the target node is the terminal node, the information on the parent node is included in the node information in addition to the identification name, the IP address, and the type (the information indicating which one of a PC, a server, a network printer, and the like the target node is) of the target node, as illustrated in a lower end of FIG. 4. The information on the parent node includes the “identification name of the parent node” and the “connection port number of the parent node” which are described above with reference to FIG. 3.

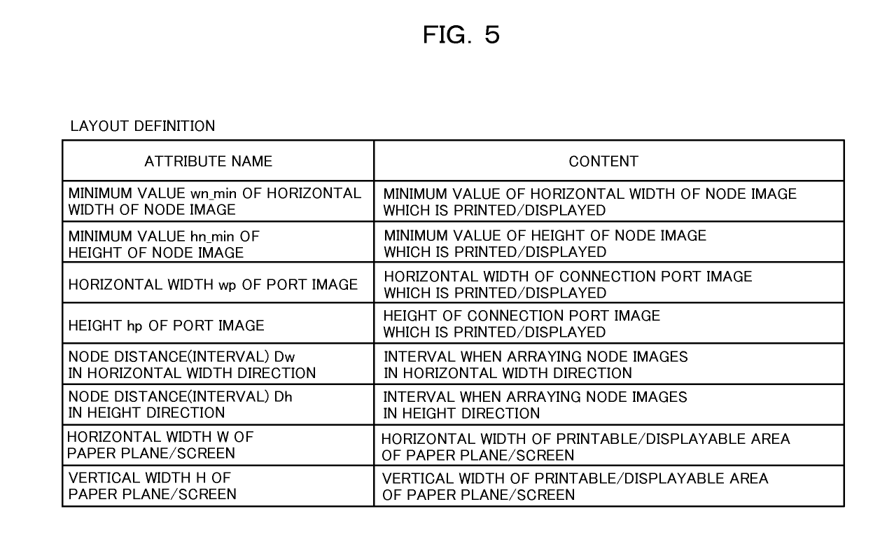

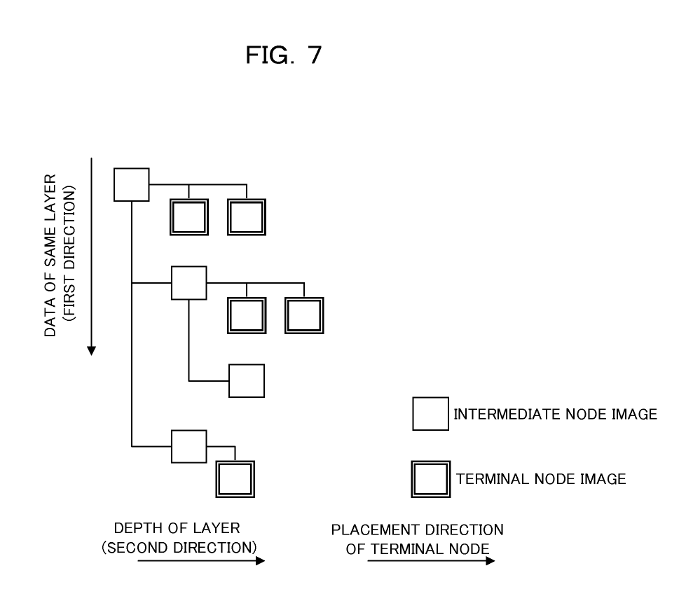

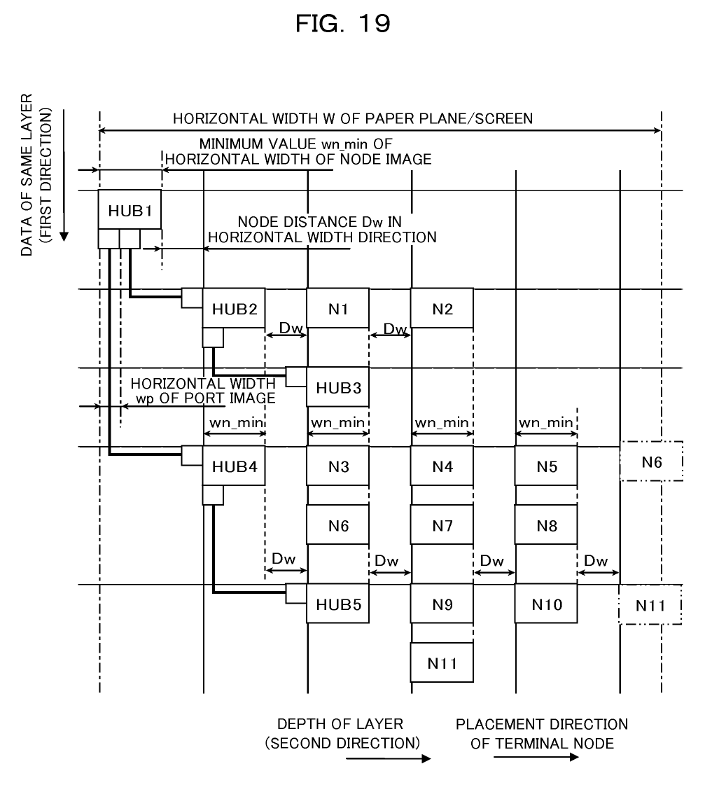

The layout definition storing unit 13 stores a layout definition which a network configuration diagram preparing unit 22 to be described below uses when preparing the configuration diagram. The layout definition includes, for example, a node image horizontal width minimum value wn_min, a node image height minimum value hn_min, a port image horizontal width wp, a port image height hp, a horizontal width direction node distance Dw, a height direction node distance Dh, a paper plane/screen horizontal width W, and a paper plane/screen vertical width H, as illustrated in FIG. 5. Note that, FIG. 5 is a diagram for describing the layout definition which the network configuration diagram preparing unit 22 to be described below uses when preparing the configuration diagram. In addition, in the embodiment, as described below with reference to FIGS. 7, 19, and the like, a height direction or a vertical width direction corresponds to a first direction in which intermediate node images of the same layer are placed and a horizontal width direction corresponds to a second direction which is perpendicular to the first direction and indicates a depth direction of the layer of the intermediate node.

The node image horizontal width minimum value wn_min is a minimum value of a horizontal width of the corresponding node image at the time of printing or displaying the node image on the paper plane or screen.

The node image height minimum value hn_min is a minimum value of the height of the corresponding node image at the time of printing or displaying the node image on the paper plane or screen.

The port image horizontal width wp is a horizontal width of the corresponding port image at the time of printing or displaying the port image on the paper plane or screen.

The port image height hp is the height of the corresponding port image at the time of printing or displaying the port image on the paper plane or screen.

The horizontal width direction node distance Dw is a distance between two corresponding node images at the time of arraying and placing two node images in the horizontal width direction on the paper plane or screen.

The height direction node distance Dh is a distance between two corresponding node images at the time of arraying and placing two node images in the height direction on the paper plane or screen.

The paper plane/screen horizontal width W is a horizontal width of a printable or displayable area on the paper plane or screen.

The paper plane/screen vertical width H is a vertical width, that is, a height of the printable or displayable area on the paper plane or screen.

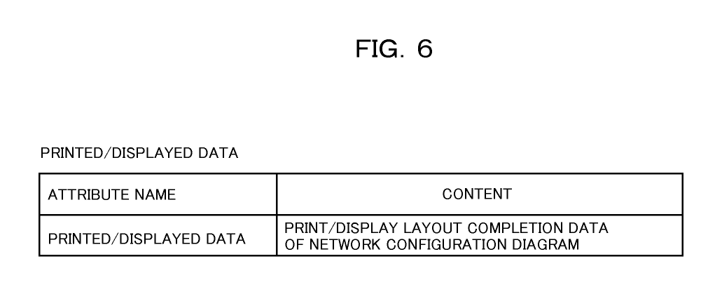

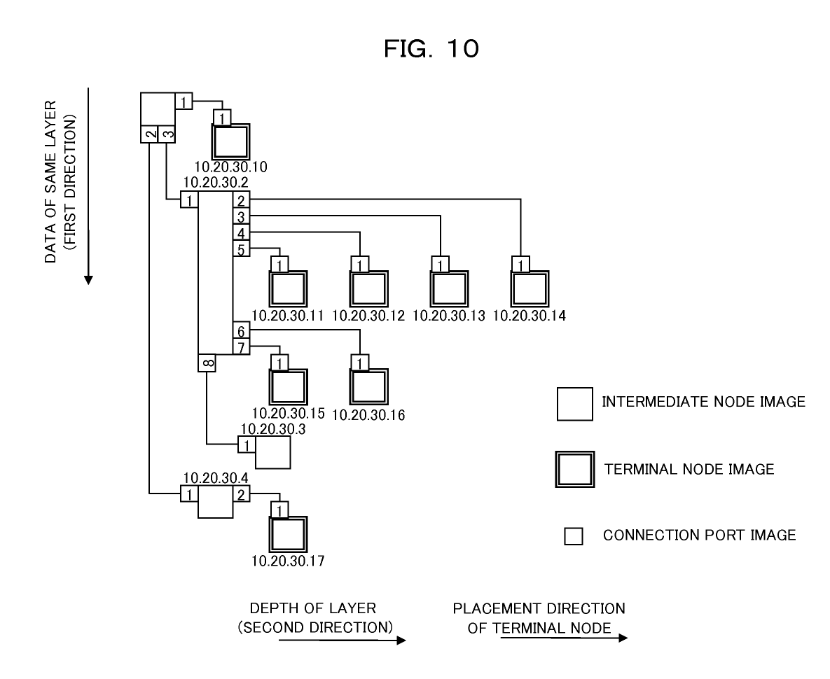

The layout completion data storing unit 14 stores print/display data prepared by the network configuration diagram preparing unit 22 to be described below. The print/display data is, for example, printing or displaying layout completion data of network configuration diagrams prepared as illustrated in FIGS. 10, 23, 24, and 25B by the network configuration diagram preparing unit 22 to be described below, as illustrated in FIG. 6. Note that, FIG. 6 is a diagram for describing the print/display data stored in the layout completion data storing unit 14.

The processing unit 20 serves as the network configuration information collecting unit 21 and the network configuration diagram preparing unit 22 which are described below.

The network configuration information collecting unit 21 collects the network configuration information (see FIGS. 3 and 4) from the collection target network 100, based on the collection target network information (see FIG. 2) stored in the collection target network information storing unit 11. That is, the network configuration information collecting unit 21 collects the node information of the intermediate node or the terminal node constituting the network 100 from the collection target network 100 designated by the collection target network information as the network configuration information and stores the collected node information in the network configuration information storing unit 12. Note that, the processing unit 20 executes an application program stored in the storage unit 10 to implement a function of the network configuration information collecting unit 12.

The network configuration diagram preparing unit 22 prepares the network configuration diagram, based on the node information (see FIGS. 3 and 4) included in the network configuration information stored in the network configuration information storing unit 12 and the layout definition (see FIG. 5) stored in the layout definition storing unit 13. The network configuration diagram preparing unit 22 has functions as a judgment unit 221, a first placement unit 222, a second placement unit 223, a first wiring unit 224, a second wiring unit 225, a first additional writing unit 226, and a second additional writing unit 227. The processing unit 20 executes a configuration diagram preparation program stored in the storage unit 10 to implement the functions.

Hereinafter, the functions will be described with reference to FIGS. 7 to 10. FIGS. 7 to 10 are diagrams illustrating a status of a preparation process of the network configuration diagram. In FIGS. 7 to 10, a rectangular block of a single periphery indicates the intermediates node image and a rectangular block of double peripheries indicates the terminal node image. Further, in FIGS. 7 to 10, a direction (first direction) in which the intermediate node images of the same layer are placed is a vertical direction and a direction (second direction) indicating a depth direction of the layer of the intermediate node is a horizontal direction. The first direction and the second direction are perpendicular to each other and the layer of the intermediate node deepens toward a right side from a left side.

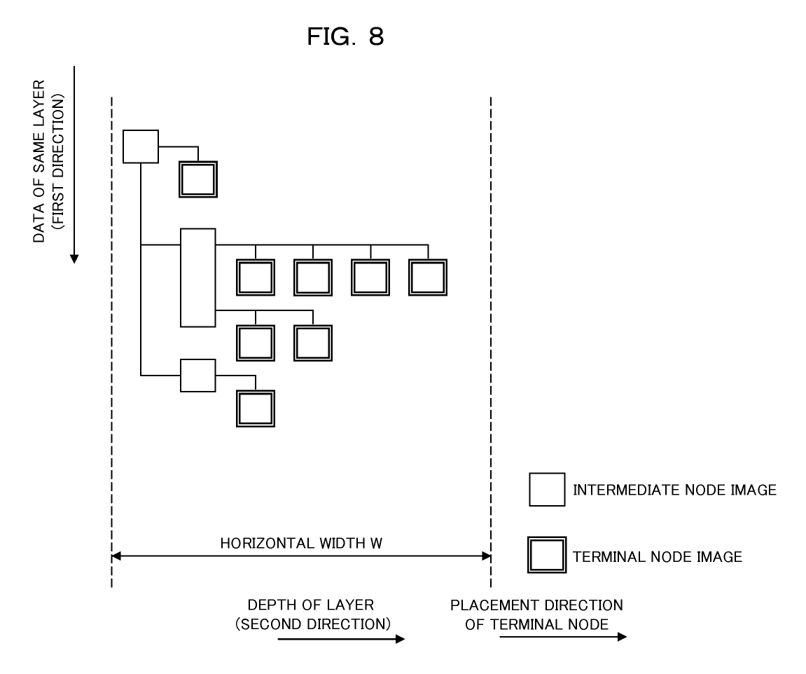

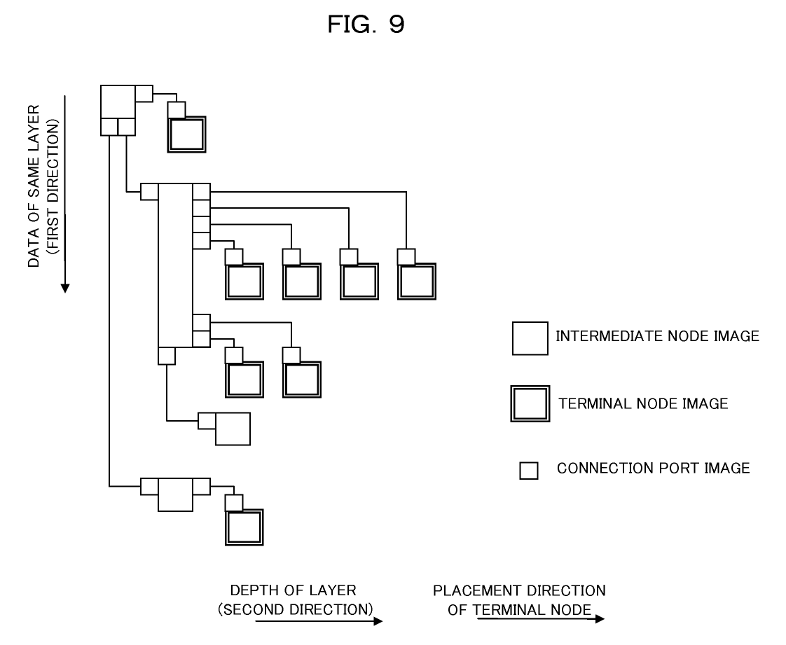

Note that, FIG. 7 is a diagram for describing placement operations of the first placement unit 222 and the second placement unit 223. FIG. 8 is a diagram for describing a parallel placement operation by the second placement unit 223. FIG. 9 is a diagram for describing a size determining operation by the first placement unit 222, and operations by the first wiring unit 224 and the second wiring unit 225. FIG. 10 is a diagram for describing operations by the first additional writing unit 226 and the second additional writing unit 227.

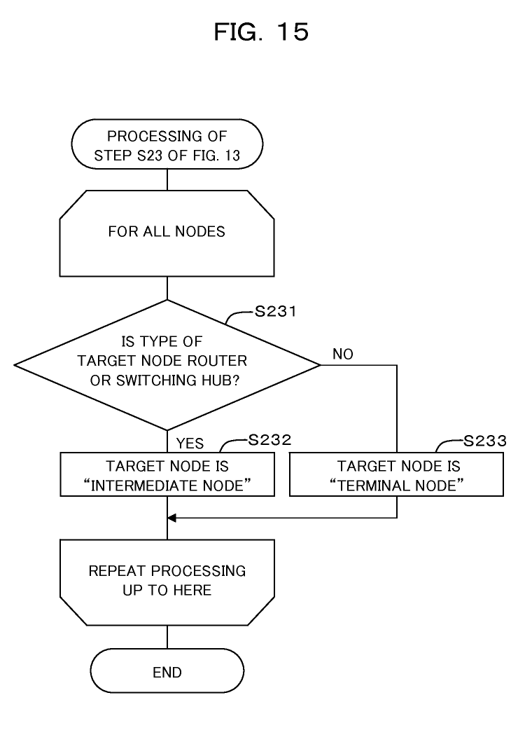

The judgment unit 221 judges whether each node depicted in the network configuration diagram as the node image is the intermediate node or the terminal node, based on the node information. In detail, the judgment unit 221 judges that the corresponding target node is the intermediate node when the type of the target node is any one of the router, the switching hub, and the like by referring to the node type of the node information included in the network configuration information read from the storage unit 12. Meanwhile, the judgment unit 221 judges that the corresponding target node is the terminal node in the case where the type of the target node is any one of the PC, the server, the network printer, and the like. The judgment processing by the judgment unit 221 will be described below in detail with reference to FIG. 15.

The first placement unit 222 has a function to place the intermediate node image of the node judged as the intermediate node by the judgment unit 221 in the tree form illustrated in FIG. 7 in the network configuration diagram, based on the node information. The tree of the intermediate node image has two directions described above, that is, the first direction in which the intermediate node images of the same layer are placed and the second direction which is perpendicular to the first direction and indicates the depth direction of the layer of the intermediate node. Further, the intermediate node images placed by the first placement unit 222 are rectangular blocks having sides parallel to the first direction and the second direction, as illustrated in FIGS. 7 to 10.

The second placement unit 223 has a function to place the terminal node image of the node judged as the terminal node by the judgment unit 221 at a location in the second direction (right direction) from the intermediate node image of the parent node (upper intermediate node) of the corresponding terminal node, which is placed by the first placement unit 222, as illustrated in FIG. 7. The terminal node image placed by the second placement unit 223 is the rectangular block having the sides parallel to the first direction and the second direction, as illustrated in FIGS. 7 to 10 and the second placement unit 223 places all terminal node images in the configuration diagram as rectangular blocks having the same shape and the same size.

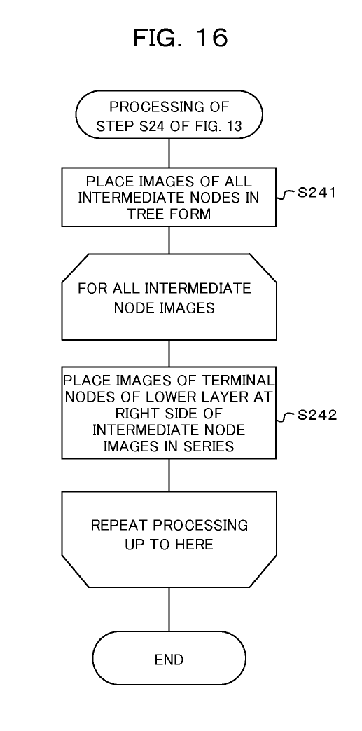

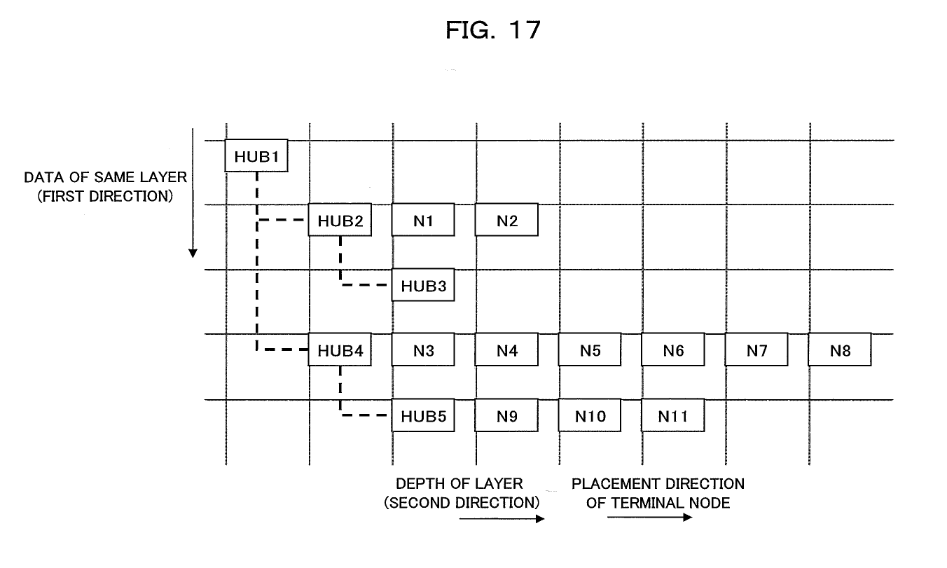

By the placement functions of the first placement unit 222 and the second placement unit 223, the configuration diagram is prepared so that the terminal node image is extended and placed in the right direction (second direction) while the intermediate node image is extended and placed in a downward direction (first direction), as a whole. The placement processing will be described below in detail with reference to FIGS. 16 and 17.

In the case where a plurality of terminal node images placed in the second direction from the intermediate node image exceed a limit location of the second direction which is set in advance for the configuration diagram, the second placement unit 223 also has a function to place the terminal node image, which exceeds the limit location, alternately with the terminal node image which does not exceed the limit location between the intermediate node image and the limit location. That is, in the case where an array of the plurality of terminal node images exceed a range of the horizontal width of the layout definition, W (see FIG. 5), the second placement unit 223 performs parallel placement processing of placing the terminal node image, which exceeds the range of the horizontal width W, alternately with the terminal node image which does not exceed the range of the horizontal width W, as illustrated in FIG. 8. The parallel placement processing will be described below in detail with reference to FIGS. 17 and 19.

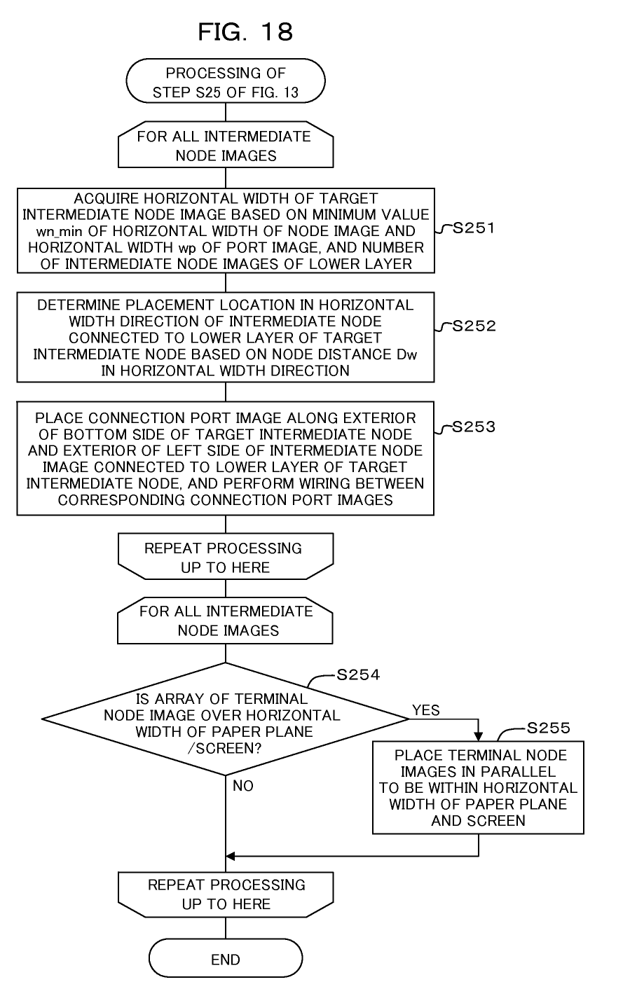

Further, as illustrated in FIG. 9, the first placement unit 222 also has a function to determine the width (horizontal width) of the intermediate node image in the second direction, based on the number of lower intermediate node images connected to the lower layer of the intermediate node image and the size (horizontal width wp) of the connection port image depicted to correspond to each lower intermediate node image in the configuration diagram. The first placement unit 222 also has a function to determine the horizontal width direction placement location of the intermediate node image connected to the lower layer of the target node image, based on the determined horizontal width of the intermediate node image and the horizontal width direction node distance Dw. Note that, the horizontal width of the connection port image, wp and the horizontal width direction node distance Dw are defined as the layout definition (see FIG. 5). The determination processing of the horizontal width of the intermediate node image or the determination processing of the placement location of the horizontal width direction will be described below in detail with reference to FIGS. 18 and 19.

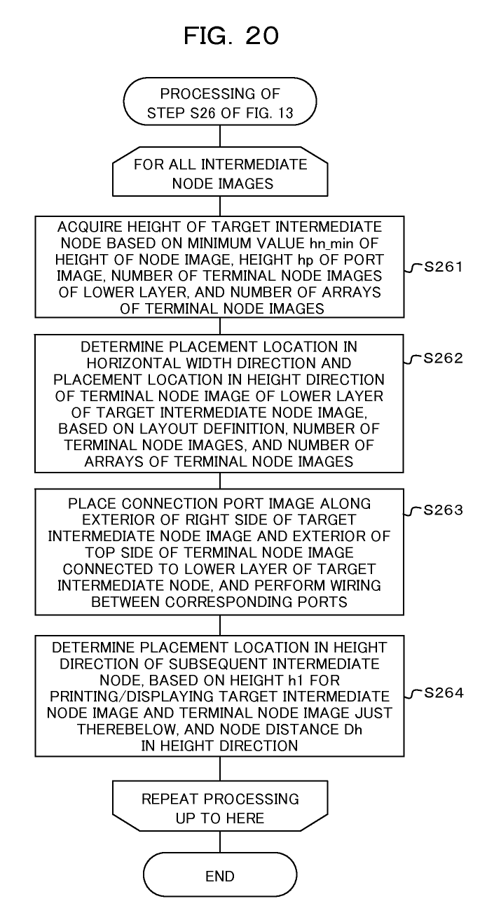

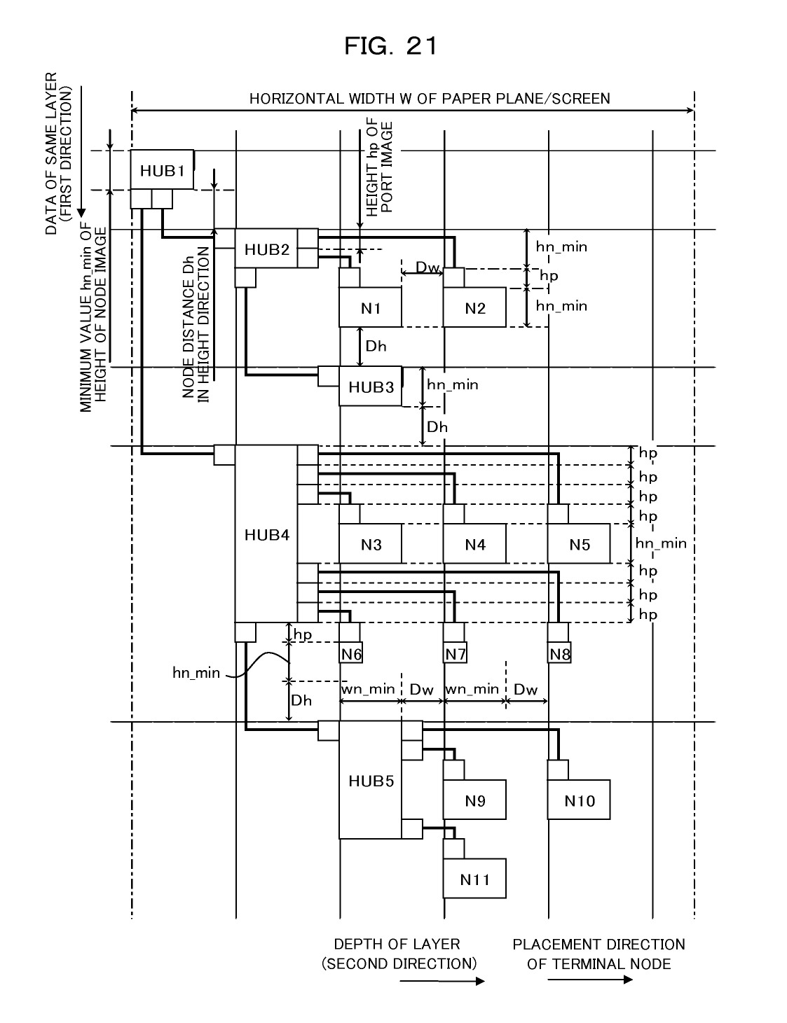

Further, the first placement unit 222 also has a function to determine the width (vertical width/height) of the intermediate node image in the first direction, based on the number of lower terminal node images connected to the lower layer of the intermediate node image, the number of arrays of lower terminal node images which are placed alternately with each other, the size (height hp) of the connection port image depicted to correspond to each lower terminal node image in the configuration, and the node image height minimum value hn_min, as illustrated in FIG. 9. The first placement unit 222 also has a function to determine the height direction placement location of the intermediate node image connected to the lower layer of the target node image, based on the determined height of the intermediate node image, the height direction node distance Dh, the height of the connection port image, hp, and the node image height minimum value hn_min. Note that, the number of arrays of lower terminal node images which are placed alternately with each other is a number depending on the number of arrays performed by the function of the second placement unit 223. Further, the height of the connection port image, hp, the node image height minimum value hn_min, and the height direction node distance Dh are defined as the layout definition (see FIG. 5). The determination processing of the height of the intermediate node image or the determination processing of the height direction placement location of the intermediate node image will be described below in detail with reference to FIGS. 20 and 21.

Further, the second placement unit 223 has a function to determine the horizontal width direction placement location of the terminal node image connected to the lower layer of each intermediate node image, based on the node image horizontal width minimum value wn_min and the horizontal width direction node distance Dw. Further, the second placement unit 223 also has a function to determine the height direction placement location of the terminal node image connected to the lower layer of each intermediate node image, based on the node image height minimum value hn_min and the port image height hp, and the number of the lower terminal node images or the number of arrays. The determination processing of the placement location of the terminal node image will be described below in detail with reference to FIGS. 20 and 21.

The first wiring unit 224 has a function to place the connection port image for each lower intermediate node image connected to the lower layer of the intermediate node image along an exterior of a lower side of the intermediate node image and place the connection port image for the intermediate node image along an exterior of a left side of each lower intermediate node image, in the configuration diagram, as illustrated in FIG. 9. Further, the first wiring unit 224 also has a function to perform wiring between the connection port image for each lower intermediate node image at the intermediate node image side and the connection port image for the intermediate node image at each lower intermediate node image side without crossing each other. The wiring processing by the first wiring unit 224 will be described below in detail with reference to FIGS. 18 and 19.

The second wiring unit 225 has a function to place the connection port image for each terminal node image connected to the intermediate node image along an exterior of a right side of the intermediate node image and place the connection port image for the intermediate node along an exterior of an upper side of each terminal node image, in the configuration diagram, as illustrated in FIG. 9. Further, the second wiring unit 225 also has a function to perform wiring between the connection port image for each terminal node image at the intermediate node side and the connection port image for the intermediate node at each terminal node image side without crossing each other. The wiring processing by the second wiring unit 225 will be described below in detail with reference to FIGS. 20 and 21.

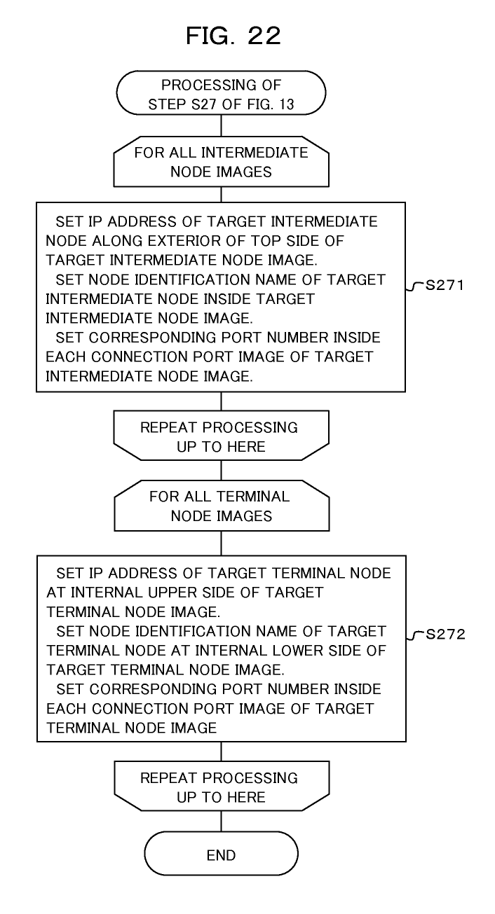

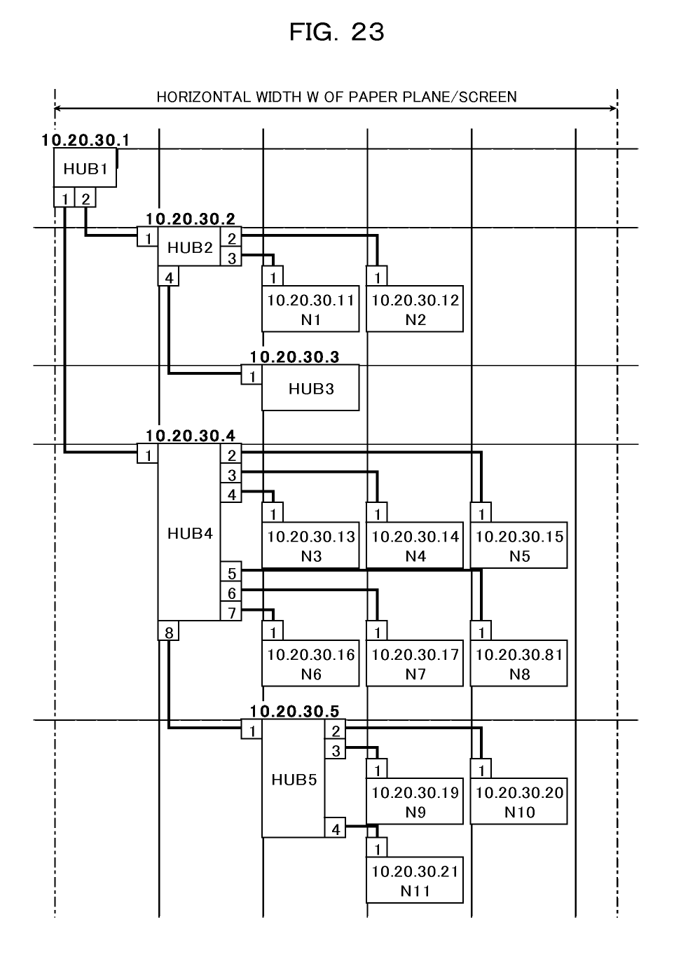

The first additional writing unit 226 has a function to add the node identification name or the IP address of each intermediate node image to each intermediate node image in the configuration diagram and add the port number to each connection port image related to each intermediate node image in the configuration diagram, based on the node information in the network configuration information storing unit 12, as illustrated in FIG. 10. Note that, in the example illustrated in FIG. 10, the IP address of each intermediate node is added along an upper portion of an upper side of each intermediate node image and the port number is added into each port image of each intermediate node. In addition, the node identification name or an MAC address of each intermediate node may be added to each intermediate node image. The addition processing by the first additional writing unit 226 will be described below in detail with reference to FIGS. 22 and 23.

The second additional writing unit 227 has a function to add the node identification name or the IP address of each terminal node image to each terminal node image in the configuration diagram and add the port number to each connection port image related to each terminal node image in the configuration diagram, based on the node information in the network configuration information storing unit 12, as illustrated in FIG. 10. Note that, in the example illustrated in FIG. 10, the IP address of each terminal node is added along a lower portion of a lower side of each terminal node image and the port number is added into each port image of each terminal node. In addition, the node identification name or an MAC address of each terminal node may be added to each terminal node image. The addition processing by the second additional writing unit 227 will be described below in detail with reference to FIGS. 22 and 23.

Note that, in FIG. 10, the IP address of the intermediate node is added along the upper portion of the upper side of the intermediate node image so as not to be duplicated with the port number or wiring and the IP address of the terminal node is added along a lower portion of a lower side of the terminal node image so as not to be duplicated with the port number or wiring. However, the node information such as the IP address, or the like may be added to all locations if the IP address is a location which is easy for a user to view. For example, the node information may be added to a left side in the intermediate node image and to a right side in the terminal node, and may be added to the inside of the node image.

The print/display data of the network configuration diagram prepared as illustrated in FIG. 10 by the network configuration diagram preparing unit 22 is stored in the layout completion data storing unit 14 as layout completion data.

The output interface unit (output unit) 30 outputs the print/display data stored in the layout completion data storing unit 14 to a print unit 2 at the time of printing the print/display data, and outputs the print/display data to a display unit at the time of displaying the print/display data.

[2] Operation of Configuration Diagram Preparing Apparatus

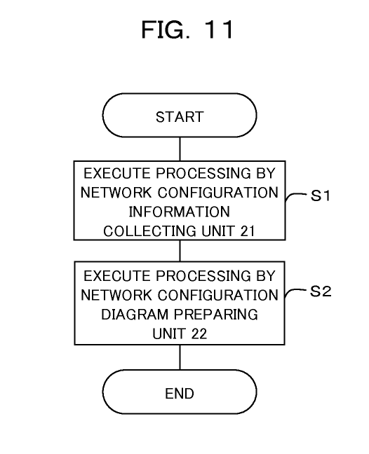

Next, the processing by the configuration diagram preparing apparatus 1 configured as described above will be described in more detail with reference to FIGS. 11 to 24.

[2-1] Overall Processing by Configuration Diagram Preparing Apparatus

The overall processing by the configuration diagram preparing apparatus 1 will be described in accordance with a flowchart (steps S1 and S2) illustrated in FIG. 11.

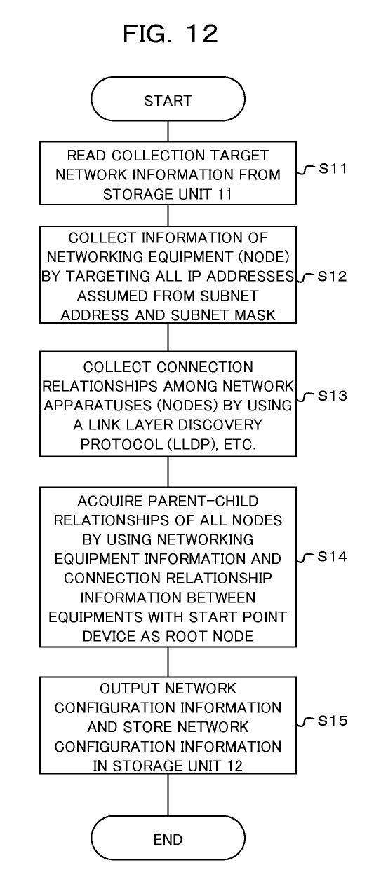

First, in the configuration diagram preparing apparatus 1, network configuration information is collected from a collection target network 100 by a network configuration information collecting unit 21, based on collection target network information stored in a collection target network information storing unit 11. That is, node information of an intermediate node or a terminal node constituting the network 100 is collected by the network configuration information collecting unit 21 from the collection target network 100 designated by the collection target network information as the network configuration information, and then stored in the network configuration information storing unit 12 (step S1). Detailed processing by the network configuration information collecting unit 21 will be described below with reference to FIG. 12.

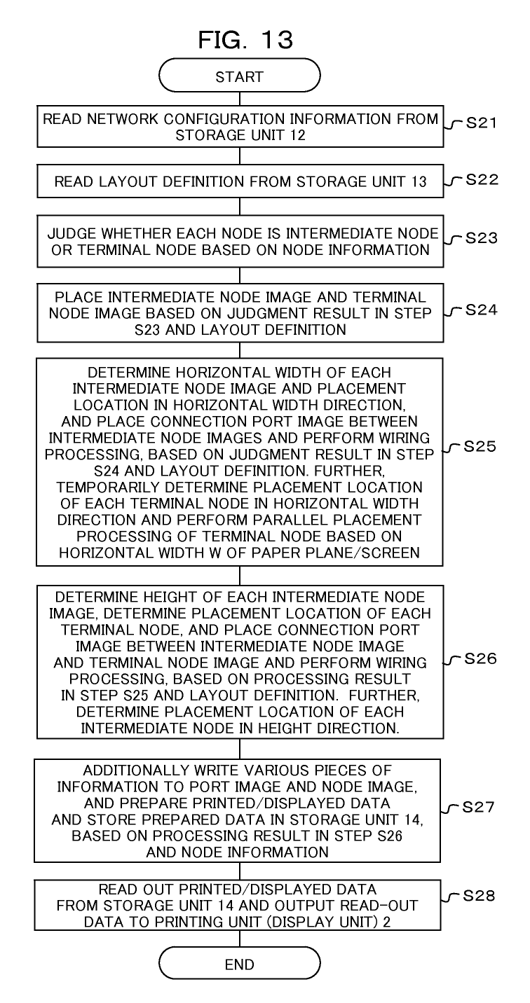

When the network configuration information is collected, a network configuration diagram, that is, data for printing or displaying the network configuration diagram is prepared by a network configuration diagram preparing unit 22, based on the collected network configuration information and a layout definition of a storing unit 13 (step S2). Detailed processing by the network configuration diagram preparing unit 22 will be described below with reference to FIGS. 13 to 24.

[2-2] Processing by Network Configuration Information Collecting Unit

Processing by the network configuration information collecting unit 21 will be described in accordance with a flowchart (steps S11 to S15) illustrated in FIG. 12.

The network configuration information collecting unit 21 first reads collection target network information (see FIG. 2) from a collection target network information storing unit 11 (step S11). In addition, the network configuration information collecting unit 21 collects information on networking equipments from the networking equipments designated by all IP addresses assumed from a collection target subnet address and a collection target subnet mask (step S12). Further, the network configuration information collecting unit 21 collects connection relationship information among networking equipments by using a link layer discovery protocol (LLDP), or the like (step S13).

In addition, the network configuration information collecting unit 21 acquires a parent-child relationship of all of the nodes in the collection target network 100, based on the networking equipment information collected in step S12 and the connection relationship information between the networking equipments collected in step S13 by using the start point device designated by the collection target network information as the root node.

The network configuration information collecting unit 21 outputs the information acquired in steps S12 to S14 as the network configuration information (see FIG. 3 or 4) and stores the output information in the network configuration information storing unit 12 (step S15).

[2-3] Processing by Network Configuration Diagram Preparing Unit

Processing by the network configuration diagram preparing unit 22 will be described in accordance with a flowchart (steps S21 to S28) illustrated in FIG. 13.

The network configuration diagram preparing unit 22 first reads the network configuration information (see FIG. 3 or 4) from the network configuration information storing unit 12 (step S21) and reads the layout definition (see FIG. 5) from the layout definition storing unit 13 (step S22).

In step S23, the judgment unit 221 judges whether each node depicted in the network configuration diagram as the node image is the intermediate node or the terminal node, based on the information read in step S21. The processing by step S23 will be described below in detail with reference to FIG. 15.

In step S24, the intermediate node image and the terminal node image are placed based on a judgment result in step S23 and the information read in step S21. In placement processing in step S24, placement locations of the intermediate node image and the terminal node image are not determined but approximate placement locations of the intermediate node image and the terminal node image are temporarily determined, and the placement processing is executed by using the functions of the first placement unit 222 and the second placement unit 223. The processing by step S24 will be described below in detail with reference to FIGS. 16 and 17.

In step S25, a horizontal width of each intermediate node image is determined based on a placement result in step S24 and the layout definition read in step S22. The horizontal width direction placement location of the intermediate node connected to the lower layer of the intermediate node image is determined based on the determined horizontal width of the intermediate node image and the layout definition. Further, the connection port images for connecting the intermediate node images are placed and wiring processing among the corresponding connection port images is performed. Thereafter, the horizontal width direction location of each terminal node is temporarily determined and parallel placement processing of the terminal node image is executed along the horizontal width W of the paper plane/screen. Note that, the determination processing of the horizontal width of the intermediate node and the determination processing of the horizontal width direction placement location are executed by using the function of the first placement unit 222. Further, the placement processing and the wiring processing of the connection port image are executed by the first wiring unit 224 and the parallel placement processing of the terminal node image is executed by using the second placement unit 223. The processing by step S25 will be described below in detail with reference to FIGS. 18 and 19.

In step S26, the height of each intermediate node image is determined and a lateral placement location and a height direction placement location of the terminal node image connected to the lower layer of the corresponding intermediate node image are determined, based on a processing result in step S25 and the layout definition read in step S22. Further, the connection port images for connecting the intermediate node images and the terminal node images are placed and wiring processing among the corresponding connection port images is performed. The height direction placement location of the intermediate node connected to the lower layer of the intermediate node image is determined based on the determined height of the intermediate node image and the layout definition. Note that, the determination processing of the height of the intermediate node and the determination processing of the height direction placement location are executed by using the function of the first placement unit 222. Further, the determination processing of the lateral placement location of the terminal node and the determination processing of the height direction placement location are executed by using the function of the second placement unit 223 and the placement processing and the wiring processing of the connection port image are executed by using the second wiring unit 225. The processing by step S26 will be described below in detail with reference to FIGS. 20 and 21.

In step S27, an output location of information such as the port number or node identification name is determined to be added to the connection port image or each node image and the print/display data of the network configuration diagram is prepared, based on a processing result in step S26 and the node information read in step S21. The prepared print/display data is stored in the layout completion data storing unit 14 as the layout completion data. Note that, the addition processing of the information is executed by using the first additional writing unit 226 and the second additional writing unit 227. The processing by step S27 will be described below in detail with reference to FIGS. 22 to 24.

The print/display data stored in the layout completion data storing unit 14 is output to the print unit 2 at the time of printing and output to the display unit at the time of displaying, by the output interface unit 30 (step S28).

Note that, the order of processing procedures by steps S23 to S27 may be changed as needed or the processing procedures may be executed while separate processing is executed and requested information may be acquired or referred to as requested. For example, the judgment processing of step S23 may be performed as needed while the placement processing of step S24 is executed. Further, the parallel placement processing of step S25 may be performed while processing of arraying the terminal node at a right side of the intermediate node is executed in step S24.

[2-4] Detailed Processing by Network Configuration Diagram Preparing Unit

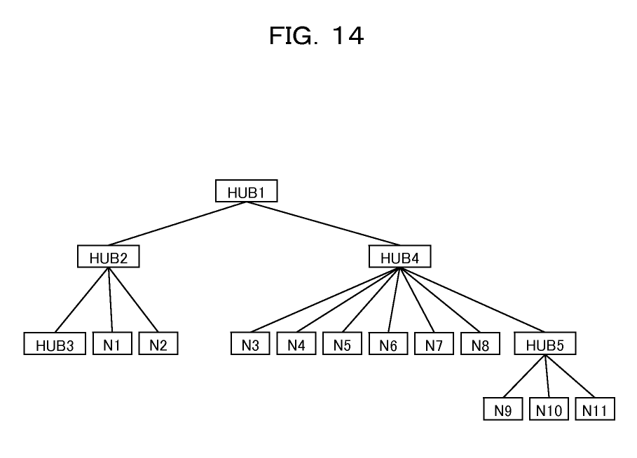

Hereinafter, detailed processing in steps S23 to S27 will be described with respect to a case in which the network configuration of the collection target network 100 has the tree structure illustrated in FIG. 14. Note that, FIG. 14 is a diagram illustrating a detailed configuration example (tree structure) of a configuration diagram preparation target network 100 and in the example illustrated in FIG. 14, two intermediate nodes HUB2 and HUB 4 are connected to a lower layer of a root node HUB1 and one intermediate node HUB3 and two terminal nodes N1 and N2 are connected to a lower layer of the intermediate node HUB2. In addition, six terminal nodes N3 to N8 and one intermediate node HUB5 are connected to a lower layer of the intermediate node HUB4 and three terminal nodes N9 to N11 are connected to a lower layer of the intermediate node HUB5.

[2-4-1] Detailed Processing of Step S23

The processing executed in step S23 of FIG. 13, that is, the judgment processing by the judgment unit 221 will be described in accordance with a flowchart (steps S231 to S233) illustrated in FIG. 15.

In step S23, for all nodes included in the network configuration information of the collection target network 100, the judgment unit 221 judges which type of node each node is, based on a node type included in node information.

That is, the judgment unit 221 judges whether the type of the target node is the router or the switching hub by referring to the node type of each node (step S231). In the case where the type of the target node is the router or the switching hub (route YES of step S231), it is judged that the target node is the intermediate node (step S232). Further, in the case where the type of the target node is not the router or the switching hub (route NO of step S231), it is judged that the target node is the terminal node (step S233). The judgment result is stored to correspond to each node in the storage unit 10. The processing of steps S231 to S233 is repeatedly executed for all nodes.

[2-4-2] Detailed Processing of Step S24

Processing executed in step S24 of FIG. 13, that is, placement processing of a node image by the first placement unit 222 and the second placement unit 223 will be described in accordance with a flowchart (steps S241 and S242) illustrated in FIG. 16. Note that, in order to describe the processing illustrated in FIG. 16 in detail, FIG. 17 illustrates a status of a network configuration diagram at a completion time of the processing illustrated in FIG. 16.

First, the first placement unit 222 places intermediate node images of all intermediate nodes included in the network configuration information of the collection target network 100 in the tree form based on the node information (step S241). In a tree of the intermediate node images HUB1 to HUB5 illustrated in FIG. 17, a downward direction is a first direction in which the intermediate node images of the same layer are placed and a right direction is a second direction which is a depth direction of the layer of the intermediate node. In FIG. 17, the intermediate node image HUB2 is placed obliquely at a lower right side of the intermediate node image HUB1 and the intermediate node image HUB3 is placed obliquely at a lower right side of the intermediate node image HUB2. Further, the intermediate node image HUB4 which is the same layer as the intermediate node image HUB2 is placed just below the intermediate node image HUB2 and the intermediate node image HUB5 is placed obliquely at a lower right side of the intermediate node image HUB4.

Subsequently, for each intermediate node included in the network configuration information of the collection target network 100, the second placement unit 223 places terminal node images of a terminal node connected to a lower layer of the corresponding intermediate node which are arrayed in line at a right direction of the intermediate node images of the corresponding intermediate node (step S242). The processing of step S242 is repeatedly executed for all intermediate node images. In FIG. 17, terminal nodes N1 and N2 are placed in line in a right direction of the intermediate node image HUB3, terminal nodes N3 to N8 are placed in line in a right direction of the intermediate node image HUB4, and the terminal nodes N9 to N11 are placed in line in a right direction of the intermediate node image HUB5.

By the placement processing of steps S241 and S242, the intermediate node images are extended and placed in a downward direction and the terminal node images are extended and placed in a right direction. A placement location of each node image at this time is temporary.

Note that, in FIG. 17, identification names HUB1 to HUB5 and N1 to N11 of nodes corresponding to the respective node images are depicted in the rectangular blocks representing the respective node images. Further, in FIG. 17, for better understanding connection relationships (tree structure) of the intermediate node images HUB1 to HUB5, dotted lines depending on the connection relationships are displayed among the intermediate node images HUB1 to HUB5. In addition, in FIG. 17, a grid for defining a temporary placement location of each node image is expressed by the dotted line.

[2-4-3] Detailed Processing of Step S25

The processing executed in step S25 of FIG. 13, that is, the determination processing of a horizontal width or a horizontal width direction placement location of the intermediate node image, wiring processing among the intermediate node images, and the parallel placement processing of the terminal node images will be described in accordance with a flowchart (steps S251 to S255) illustrated in FIG. 18. Note that, in order to describe the processing illustrated in FIG. 18 in detail, FIG. 19 illustrates a status of a network configuration diagram at a completion time of the processing illustrated in FIG. 18.

First, the horizontal width of the target intermediate node image is determined, based on the node image horizontal width minimum value wn_min and the port image horizontal width wp included in the layout definition and the number of the intermediate node images connected to the lower layer, by the first placement unit 222 for each intermediate node image (step S251). A connection port image for the intermediate node image connected to the lower layer is placed along an exterior of a lower side of the intermediate node image in the embodiment. Therefore, the horizontal width of the target intermediate node image is determined as “the port image horizontal width wp”×“the number of the intermediate node images connected to the lower layer”. However, in FIG. 19, since it is defined that “the node image horizontal width minimum value wn_min”=“the port image horizontal width wp”×3, the horizontal width of the target intermediate node image becomes the “node image horizontal width minimum value wn_min” in the case where “the number of the intermediate node images connected to the lower layer” is 0 to 3 and the horizontal width of the target intermediate node image becomes “the port image horizontal width wp”×“the number of the intermediate node images connected to the lower layer” in the case where “the number of the intermediate node images connected to the lower layer” is 4 or more. All horizontal widths of the intermediate node images HUB1 to HUB5 in FIG. 19 are determined as “the node image horizontal width minimum value wn_min” (=wp×3).

When the horizontal width of the target intermediate node image is determined, the first placement unit 222 determines the horizontal width direction placement location of the intermediate node image connected to the lower layer of the target intermediate node image, based on the horizontal width direction node distance Dw included in the layout definition (step S252). That is, a right-direction location from a right-side location of the target intermediate node image by the “horizontal width direction node distance Dw” is determined as a horizontal width direction placement location of a subsequent target intermediate node image (a left-side location of the subsequent target intermediate node image).

In FIG. 19, left-side locations of the intermediate node images HUB2 and HUB4 are determined as a right-direction location from a right-side location of the intermediate node image HUB1 by the horizontal width direction node distance Dw. Further, a left-side location of the intermediate node image HUB3 is determined as a right-direction location from a right-side location of the intermediate node image HUB2 by the horizontal width direction node distance Dw and a left-side location of the intermediate node image HUB5 is determined as a right-direction location from a right-side location of the intermediate node image HUB4 by the horizontal width direction node distance Dw. Note that, the horizontal width direction node distance Dw is set to be larger than the port image horizontal width wp.

When the left-side location of the target intermediate node image is determined, the first wiring unit 224 places the connection port images along an exterior of a lower side of the target intermediate node image and an exterior of a left side of each lower intermediate node image connected to the lower layer of the target intermediate node image, and performs wiring processing among the connection port images which correspond to each other (step S253). Herein, connection port images of the same number as the number of the lower intermediate node images are placed on the exterior of the lower side of the target intermediate node image and one connection port image connected to the target intermediate node image is placed on the exterior of the left side of each lower intermediate node image. Further, a connection port image of a lowermost lower intermediate node image and a leftmost connection port image of the target intermediate node image are wired to each other and a connection port image of an uppermost lower intermediate node image and a rightmost connection port image of the target intermediate node image are wired to each other, so that wirings do not cross each other at the time of performing the wiring processing.

In FIG. 19, two connection port images are placed on an exterior of a lower side of the intermediate node image HUB1, a connection port image on an exterior of a left side of the intermediate node image HUB4 is wired to a left connection port image, and a connection port image on an exterior of a left side of the intermediate node image HUB2 is wired to a right connection port image. Further, one connection port image is placed on an exterior of a lower side of the intermediate node image HUB2 and the connection port image and a connection port image on an exterior of a left side of the intermediate node image HUB3 are wired to each other. Further, one connection port image is placed on an exterior of a lower side of the intermediate node image HUB4 and the connection port image and a connection port image on an exterior of a left side of the intermediate node image HUB5 are wired to each other.

When wiring among the intermediate node images is completed by executing the processing of steps S251 to S253 for all intermediate nodes, the parallel placement processing of the terminal node image is executed for each intermediate node image along the horizontal width W of the paper plane/screen by the second placement unit 223 (steps S254 and S255).

That is, by the second placement unit 223, the horizontal width direction placement location of the terminal node connected to the lower layer of each intermediate node image is temporarily determined and it is judged whether the array of the terminal node images exceeds the horizontal width W of the paper plane/screen, based on the node horizontal width minimum value wn_min and the horizontal width direction node distance Dw (step S254). In the embodiment, since the horizontal widths and the heights of the respective terminal node images are constant as the node horizontal width minimum value wn_min and the node height minimum value hn_min, the horizontal width direction placement location of each terminal node image may be at least temporarily determined based on the node horizontal width minimum value wn_min and the horizontal width direction node distance Dw.

In addition, in the case where an array of a plurality of terminal node images placed in a right direction from each intermediate node image exceeds a range of the horizontal width W of the paper plane/screen (route YES of step S254), the second placement unit 223 performs parallel placement processing of placing the terminal node image which exceeds the range of the horizontal width W alternately with a terminal node image which does not exceed the range of the horizontal width W. In the case where the array of the terminal node images is not over the range of the horizontal width W of the paper plane/screen or in the case where the terminal node image is not connected to the lower layer of the intermediate node image (route NO of step S254), the parallel placement processing is not executed.

In FIG. 19, a horizontal width direction distance between the left-side location of the intermediate node image HUB1 and a right end location of an array of the terminal node images N1 and N2 (a right-side location of the terminal node image N2) in the right direction of the intermediate node image HUB2 is “wn_min×4+Dw×3” and is not over the range of the horizontal width W of the paper plane/screen. Therefore, the parallel placement processing is not executed for the array of the terminal node images N1 and N2.

Contrary to this, a horizontal width direction distance between the left-side location of the intermediate node image HUB1 and a right end location of an array of the terminal node images N3 to N8 (a right-side location of the terminal node image N8) in the right direction of the intermediate node image HUB4 is “wn_min×8+Dw×7” and is over the range of the horizontal width W of the paper plane/screen. In the array of the terminal node images N3 to N8, three terminal node images N6 to N8 are over the range of the horizontal width W of the paper plane/screen, as illustrated in FIG. 19. As a result, three terminal node images N6 to N8 which are over the range of the horizontal width W are placed alternately with the terminal node images N3 to N5 which are not over the range of the horizontal width W.

Similarly, a horizontal width direction distance between the left-side location of the intermediate node image HUB1 and a right end location of an array of the terminal node images N9 to N11 (a right-side location of the terminal node image N11) in the right direction of the intermediate node image HUB5 is “wn_min×6+Dw×5” and is over the range of the horizontal width W of the paper plane/screen. In the array of the terminal node images N9 to N11, one terminal node image N11 is over the range of the horizontal width W of the paper plane/screen, as illustrated in FIG. 19. As a result, one terminal node image N11 which is over the range of the horizontal width W is placed alternately with the terminal node image N9 which is not over the range of the horizontal width W.

[2-4-4] Detailed Processing of Step S26

The processing executed in step S26 of FIG. 13, that is, the determination processing of the height or a height direction placement location of the intermediate node image, placement location determination processing of the terminal node image, and the wiring processing of the terminal node image will be described in accordance with a flowchart (steps S261 to S264) illustrated in FIG. 20. Note that, in order to describe the processing illustrated in FIG. 20 in detail, FIG. 21 illustrates a status of a network configuration diagram at a completion time of the processing illustrated in FIG. 20. The processing of steps S261 to S264 to be described below is repeatedly executed for all nodes.

First, the height of the target intermediate node image is determined based on the node image height minimum value hn_min and the port image height hp included in the layout definition, the number of the terminal node images connected to the lower layer, and the number of arrays of terminal node images which are placed alternately with each other, by the first placement unit 222 for each intermediate node image (step S261). A connection port image for the terminal node image connected to the lower layer is placed along the exterior of the right side of the intermediate node image in the embodiment. As a result, basically, the height of the target intermediate node image is determined as the “port image height hp”×the “number of terminal node images connected to the lower layer”. However, in FIG. 21, since it is defined that “the node image height minimum value hn_min”=“the port image height hp”×2, the height of the target intermediate node image becomes the “node image height minimum value hn_min” in the case where the “number of the terminal node images connected to the lower layer” is 0 to 2 and the height of the target intermediate node image becomes “the port image height hp”×“the number of the terminal node images connected to the lower layer” in the case where “the number of the terminal node images connected to the lower layer” is 3 or more. Further, in the embodiment, as illustrated in FIG. 19, since the parallel placement processing of the terminal node image is also executed, the height of the target intermediate node image is determined by considering the number of arrays of the terminal node images which are alternately placed in the case where the parallel placement processing is executed.

In FIG. 21, the heights of the intermediate node images HUB1 and HUB3 are determined as the “node image height minimum value hn_min” because the terminal node image is not connected to the lower layers of the intermediate node images HUB1 and HUB3. The height of the intermediate node image HUB2 is determined as the “node image height minimum value hn_min” (=hp×2) because two terminal node images N1 and N2 are connected to the lower layer of the intermediate node image HUB2. Further, since the terminal node images N3 to N8 of 3×2 arrays are connected to the lower layer of the intermediate node image HUB4, the height of the intermediate node image HUB4 is determined as “hp×3+(hp+hn_min)×1+hp×3=hp×7+hn_min×1”, as illustrated in FIG. 21. Further, since three terminal node images N9 to N11 are connected to the lower layer of the intermediate node image HUB5 while the three terminal node images N9 to N11 are divided into 2 arrays, the height of the intermediate node image HUB5 is determined as “hp×2+(hp+hn_min)×1+hp×1=hp×4+hn_min×1”. For example, in the case where terminal node images of m×n arrays are connected to a lower layer of an intermediate node image, the height of the intermediate node image is determined as “hp×m+(hp+hn_min)×(n−1)+hp×m=hp×(2m+n−1)+hn_min×(n−1)”.

When the height of the target intermediate node image is determined, the second placement unit 223 determines the horizontal width direction placement location of the terminal node image connected to the lower layer of the target intermediate node image, based on the node image horizontal width minimum value wn_min and the horizontal width direction node distance Dw included in the layout definition. Further, the second placement unit 223 determines the height direction placement location of the terminal node image connected to the lower layer of the target intermediate node image, based on the node image height minimum value hn_min and the port image height hp included in the layout definition, and the number of the lower terminal node images or the number of arrays (step S262).

In FIG. 21, horizontal width direction placement locations (left-side locations) and height direction placement locations (upper-side locations) of the terminal nodes N1 to N11 are determined as follows.

The left-side location of the terminal node image N1 connected to the lower layer of the intermediate node image HUB2 is determined as a right-direction location from a right-side location of the intermediate node image HUB2 by the horizontal width direction node distance Dw. The left-side location of the terminal node image N2 connected to the lower layer of the intermediate node image HUB2 is determined as a right-direction location from a right-side location of the terminal node image N1 by the horizontal width direction node distance Dw. The upper-side locations of the terminal node images N1 and N2 are determined as a lower-direction location from a lower-side location of the intermediate node image HUB2 by the port image height hp.

The left-side locations of the terminal node images N3 and N6 of a head of each array connected to the intermediate node image HUB4 are determined as a right-direction location from the right-side location of the intermediate node image HUB4 by the horizontal width direction node distance Dw. The left-side locations of the second terminal node images N4 and N7 of each array connected to the intermediate node image HUB4 are determined as a right-direction location from the right-side locations of the terminal node images N3 and N6 of heads, respectively by the horizontal width direction node distance Dw. Similarly, the left-side locations of the third terminal node images N5 and N8 of each array connected to the intermediate node image HUB4 are determined as a right-direction location from the right-side locations of the second terminal node images N4 and N7, respectively by the horizontal width direction node distance Dw.

Further, the upper-side locations of the terminal node images N3 to N5 at the first array, which are connected to the intermediate node image HUB4, are determined as a lower-direction location from the upper-side location of the intermediate node image HUB4 by “the port image height hp”×“(the number of terminal node images at the first array)+1”=“hp×4”. Further, the upper-side locations of the terminal node images N6 to N8 at the second array, which are connected to the intermediate node image HUB4, are determined as a lower-direction location from the upper-side location of the intermediate node image HUB4 by “the port image height hp”×“(the number of terminal node images at the first array)+1”+“the node image height minimum value hn_min”+“the port image height hp”×“(the number of terminal node images at the second array)+1”=“hp×8+hn_min”. Similarly, horizontal width direction placement locations (left-side locations) and height direction placement locations (upper-side locations) of the terminal node images N9 to N11 connected to the intermediate node image HUB5 are also determined.

By this configuration, when the placement location of the terminal node image connected to the lower layer of each intermediate node image is determined, the second wiring unit 225 places the connection port images and performs wiring processing among the corresponding connection port images, along the exterior of the right side of the target intermediate node image and the exterior of the upper side of each lower terminal node image connected to the lower layer of the target intermediate node image (step S263). Herein, connection port images of the same number as the number of the terminal node images connected to the lower layer are placed on the exterior of the right side of the target intermediate node image and one connection port image connected to the target intermediate node image is placed on the exterior of the upper side of each lower terminal node image. Further, a connection port image of a rightmost lower terminal node image and an uppermost connection port image of the target intermediate node image are wired to each other and a connection port image of a leftmost lower intermediate node image and a lowermost connection port image of the target intermediate node image are wired to each other, so that wirings do not cross each other at the time of performing the wiring processing.

In FIG. 21, two connection port images are placed on the exterior of the right side of the intermediate node image HUB2, a connection port image of the exterior of the upper side of the terminal node image N2 is wired to an upper connection port image, and a connection port image on the exterior of the upper side of the terminal node image N1 is wired to a lower connection port image. Further, three connection port images corresponding to the first array are consecutively placed on the exterior of the right side of the intermediate node image HUB4 and three connection port images corresponding to the second array are consecutively placed with a gap as large as “the node image height minimum value hn_min”+“the port image height hp”. In addition, the terminal node images N5, N4, and N3 are connected to three connection port images corresponding to the first array, respectively and the terminal node images N8, N7, and N6 are connected to three connection port images corresponding to the second array, respectively. Similarly, the placement processing and the wiring processing of the connection port image are performed even between the intermediate node image HUB5 and the terminal node images N9 to N11.

When wiring is performed between the target intermediate node image and the lower terminal node image, the first placement unit 222 determines the height-direction placement location of the intermediate node image connected to the lower layer of the target intermediate node image, based on a height h1 for printing/displaying the target intermediate node image and the terminal node image just therebelow and a height-direction node distance Dh (step S264). That is, a lower-direction location from the upper-side location of the target intermediate node image by “the height h1”+“the height-direction node distance Dh” is determined as a height-direction placement location of a subsequent target intermediate node image (an upper-side location of the subsequent target intermediate node image). Herein, “the height h1” becomes “the node image height minimum value hn_min” in the case where the terminal node image is not connected to the lower layer of the target intermediate node image. Further, “the height h1” becomes “the height hp of the target intermediate node image determined in step S261”+“the height hp of the connection port image”+“the node image height minimum value hn_min” in the case where the terminal node image is connected to the lower layer of the target intermediate node image.

In FIG. 21, the upper-side locations of the intermediate node images HUB2 and HUB4 are determined as a lower-direction location from the upper-side locations of the intermediate node images HUB1 and HUB3, respectively by “the node image height minimum value hn_min”+“the height direction node distance Dh”. The upper-side location of the intermediate node image HUB3 is determined as the lower-direction location from the upper-side location of the intermediate node image HUB2 by “the height of the HUB2”+“the height hp of the connection port image”+“the node image height minimum value hn_min”+“the height direction node distance Dh”=“hn_min×2+hp+Dh”. The upper-side location of the intermediate node image HUB5 is determined as the lower-direction location from the upper-side location of the intermediate node image HUB4 by “the height of the HUB4”+“the height hp of the connection port image”+“the node image height minimum value hn_min”+“the height direction node distance Dh”=“hp×8+hn_min×2+Dh”.

[2-4-5] Detailed Processing of Step S27

Processing executed in step S27 of FIG. 13, that is, additional writing processing of node information, or the like by a first additional writing unit 226 and a second additional writing unit 227 will be described in accordance with a flowchart (steps S271 and S272) illustrated in FIG. 22. Note that, in order to describe the processing illustrated in FIG. 22 in detail, FIG. 23 illustrates a status of a network configuration diagram at the time of a completion time of the processing illustrated in FIG. 22, that is, a display/print example of a configuration diagram prepared by the embodiment for the network illustrated in FIG. 16.

First, the first additional writing unit 226 additionally writes an IP address of an intermediate node corresponding to the target intermediate node image to each intermediate node image along the exterior of the upper side of the target intermediate node image, as illustrated in FIG. 23. Further, a node identification name of the same intermediate node is additionally depicted in the inside of the target intermediate node and a corresponding port number is additionally depicted in the inside of the connection port image in the target intermediate node image (step S271).

Subsequently, the second additional writing unit 227 additionally writes an IP address of a terminal node corresponding to the target terminal node image to an upper inner side of the target terminal node image even for each terminal node image, as illustrated in FIG. 23. Further, a node identification name of the same terminal node is additionally depicted in a lower inner side of the target terminal node image and a corresponding port number is additionally depicted in the inside of the connection port image in the target terminal node image (step S272).

The print/display data of the network configuration diagram prepared as illustrated in FIG. 23 is stored in the layout completion data storing unit 14 as layout completion data.

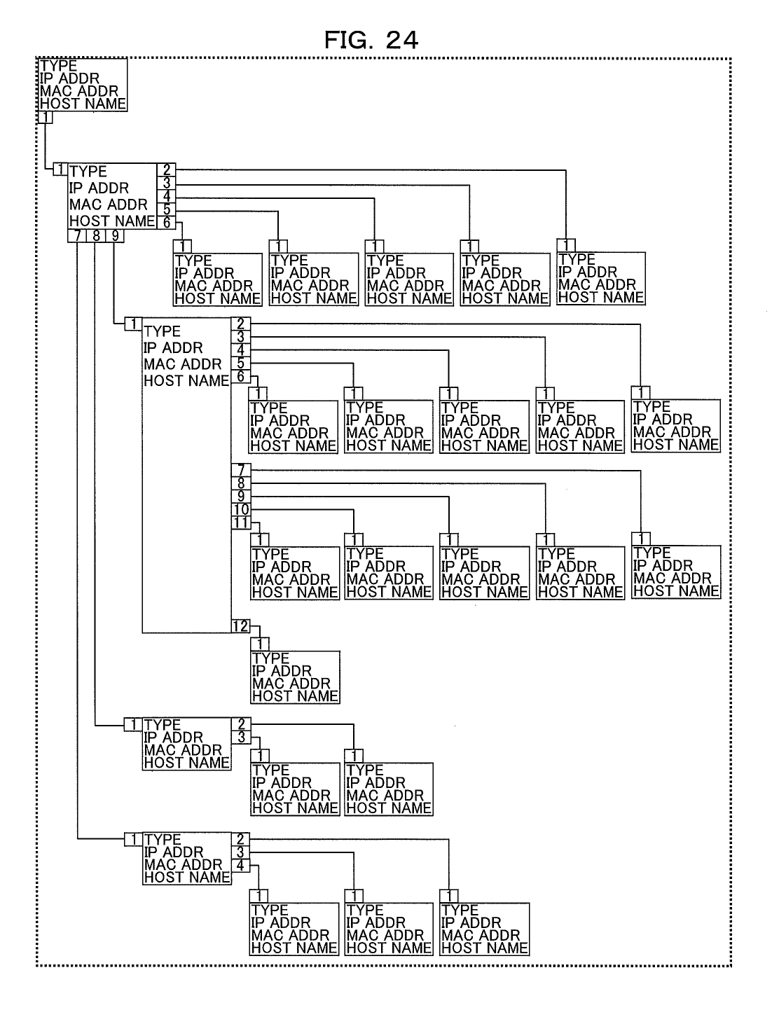

Note that, FIG. 24 is a diagram illustrating an example of more detailed display/print data prepared by the configuration diagram preparing apparatus 1. In the example of the display/print data illustrated in FIG. 24, the type ([Router], [Switch], [Server], or [PC]), an IP address, an MAC address, and a node identification name (host name) of each node are additionally depicted as “information used for the network configuration diagram” sequentially from the top in the inside of each node image. Further, in FIG. 24, a periphery of a dotted line represents a printable area/displayable area of the paper plane/screen.

[3] Effect by Configuration Diagram Preparing Apparatus

In accordance with the configuration diagram preparing apparatus 1, it is judged whether the node depicted in the configuration diagram is the intermediate node or the terminal node and thereafter, the intermediate node images are placed in the tree form, and the terminal node images are placed in a second direction perpendicular to the placement direction of the intermediate node image of the same layer. As a result, by considering a characteristic of the network configuration diagram in which the number of the terminal node images connected to the lower layer than the intermediate node image remarkably increases, the intermediate node image or the terminal node image is efficiently laid out on one paper plane or one screen. That is, when a configuration diagram of a physical network is printed on a paper medium, the paper plane may be effectively used and the screen may be effectively used at the time of displaying the configuration diagram of the physical network on the display unit.

In preparing the configuration diagram of the physical network, it is difficult to handle both visibility and the increase in an information amount to be displayed in the related art. However, the network configuration diagram prepared by the configuration diagram preparing apparatus 1 may be printed/displayed on the paper plane or screen, which is limited in size, without damaging connection information among connection ports or visibility of fundamental information such as the IP address, or the like. That is, in accordance with the configuration diagram preparing apparatus 1, the configuration diagram of the physical network may be substantially received within a limit range of a horizontal width of one paper plane or one screen.

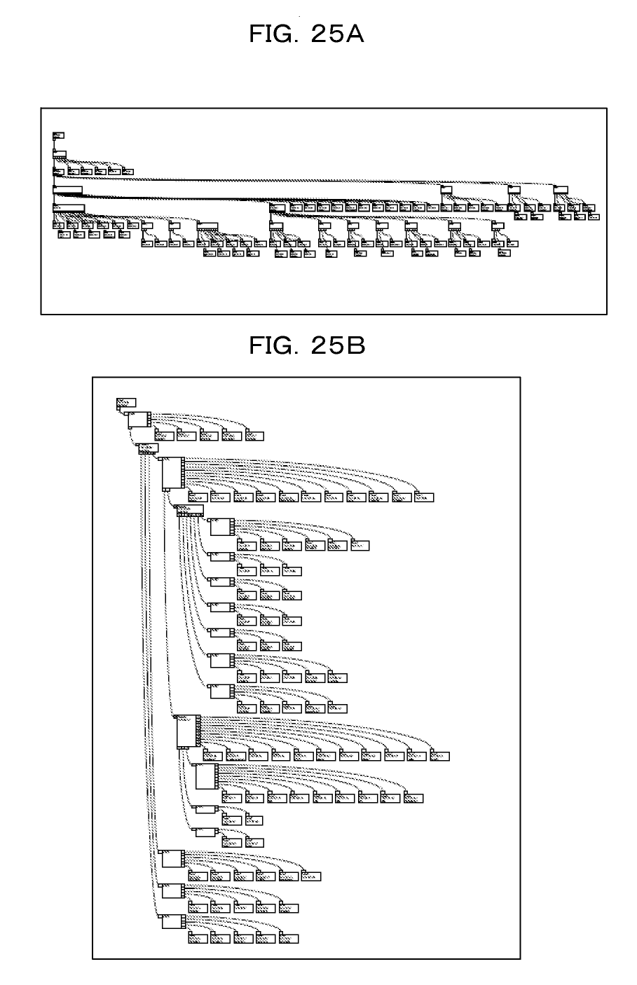

Herein, FIG. 25A is a diagram illustrating a display/print example of a network configuration diagram prepared by a method which is not in accordance with the embodiment and FIG. 25B is a diagram illustrating the display/print example of the network configuration diagram prepared by the configuration diagram preparing apparatus 1 according to the embodiment for the same network as the FIG. 25A. As can be apparently seen even though FIGS. 25A and 25B are compared with each other, it is possible to effectively use the paper plane/screen and to print/display each node image or each connection port image more largely in the case of preparing the configuration diagram by using the configuration diagram preparing apparatus 1, as compared with the case in which the configuration diagram is prepared by the method which is not in accordance with the embodiment. Therefore, information fundamental for the network configuration diagram, such as a connection relationship among various ports, or the like is expressed without damaging the visibility thereof.

[4] Others

As described above, although the embodiment of the invention has been described, the invention is not limited to the specific embodiment and various modifications and changes can be made within the scope without departing from the spirit of the invention.

In the embodiment, the first direction in which the intermediate node images of the same layer are placed is set as a vertical direction of the paper plane/screen and the second direction in which the terminal node images are placed is set as a horizontal direction of the paper plane/screen, but the first direction may be set as the horizontal direction of the paper plane/screen and the second direction may be set as the vertical direction of the paper plane/screen. Even in this case, the same operational effect as the embodiment may be obtained.

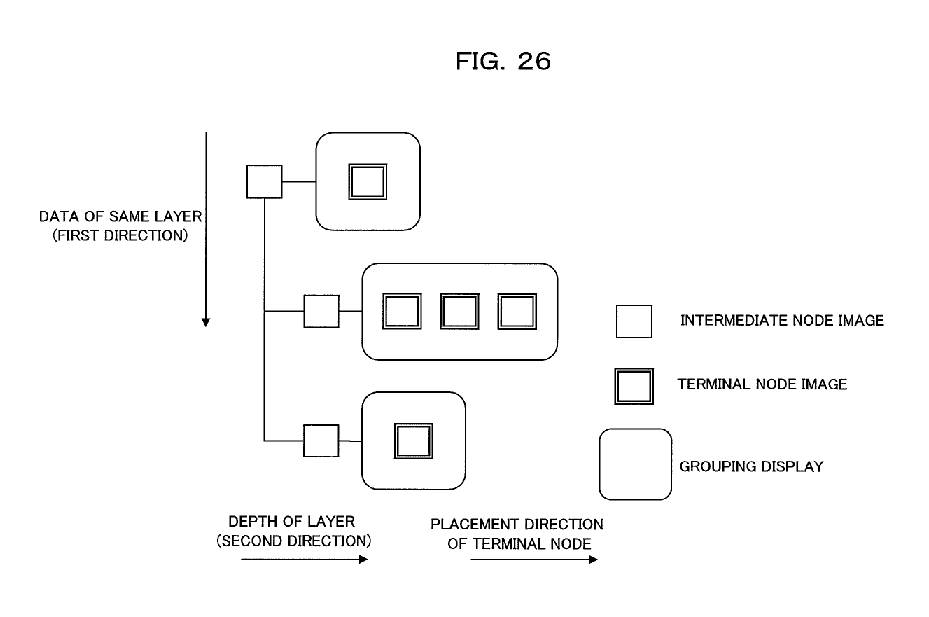

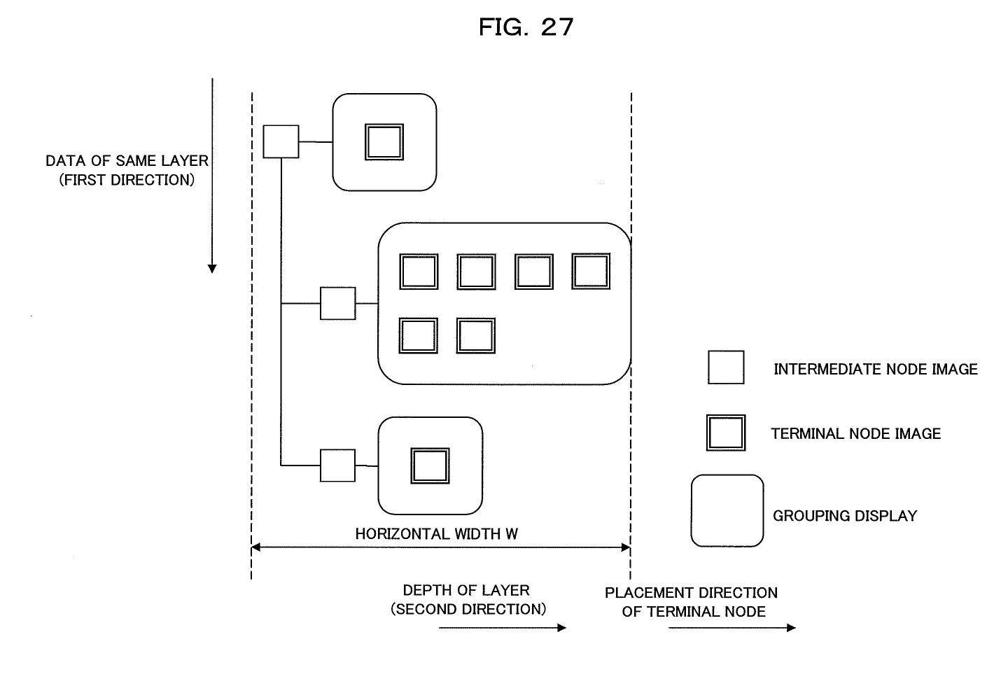

Further, in the configuration diagram prepared as illustrated in FIGS. 10, 23, 24, and 25B, the connection relationship among the connection ports is displayed in detail. However, in the case where a configuration diagram schematically illustrating the relationship between the intermediate port image and the terminal port image is prepared, for example, a configuration diagram illustrated in FIG. 26 or 27 may be prepared to be printed/displayed. Herein, FIGS. 26 and 27 are diagrams illustrating a first modified example and a second modified example of the network configuration diagram prepared by the configuration diagram preparing apparatus 1, respectively.

In the configuration diagram of the first modified example illustrated in FIG. 26, terminal node images connected to the lower layer of each intermediate node image are placed in line and grouped to be printed/displayed for each intermediate node image, at a right side of each intermediate node image.

Further, in the configuration diagram of the second modified example illustrated in FIG. 27, when the terminal node images are placed in line in a right direction, the terminal node images exceed the range of the horizontal width W, and as a result, the second placement unit 223 performs the parallel placement processing of the terminal node image. After the parallel placement processing is performed, the terminal node images are grouped to be printed/displayed for each intermediate node image.

In the case where a user schematically grasps an overall configuration of the physical network such as the connection relationship between the intermediate node and the terminal node, or the like without needing detailed information such as the connection relationship among the connection ports, or the like, grouping illustrated in FIG. 26 or 27 is effectively performed.

Meanwhile, a computer (including the CPU, an information processing apparatus, and various terminals) executes a predetermined application program (configuration diagram preparing program) to implement all or some of the functions as the judgment unit 221, the first placement unit 222, the second placement unit 223, the first wiring unit 224, the second wiring unit 225, the first additional writing unit 226, and the second additional writing unit 227.

The program is provided in a format recorded in computer-readable recording media such as flexible disk, CD (CD-ROM, CD-R, CD-RW, or the like), DVD (DVD-ROM, DVD-RAM, DVD-R, DVD-RW, DVD+R, DVD+RW, or the like), a Blu-ray disk, or the like. In this case, the computer reads a program from the recording medium, and transmits and stores the read program to and in an internal storage device or an external storage device, which is used.

Herein, the computer is a concept including hardware and an operating system (OS) and means hardware which operates under a control from the OS. Further, when the OS is unnecessary and an application program singly operates the hardware, the hardware itself corresponds to the computer. The hardware at least includes a microprocessor such as the CPU, or the like and means for reading a computer program recorded in the recording medium. The configuration diagram preparing program includes a program code which instructs the computer to implement the functions of the judgment unit 221, the placement units 222 and 223, the wiring unit 224, the wiring unit 225, and the additional writing units 226 and 227. Further, some of the functions may be implemented not by the application program but by the OS.

In the disclosed technique, the intermediate node and the terminal node in the network configuration diagram are efficiently placed on one paper plane or one screen.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A configuration diagram preparing apparatus that prepares a configuration diagram of a network having nodes including an intermediate node and a terminal node, the apparatus comprising:
a storage unit that stores node information associated with each of the nodes in the network; and
a processing unit that prepares the configuration diagram based on the node information stored by the storage unit,
wherein the processing unit includes,
a judgment unit that judges whether each node depicted as a node image in the configuration diagram is the intermediate node or the terminal node, based on the node information stored by the storage unit,
a first placement unit that places, in the configuration diagram, an intermediate node image of a node judged as the intermediate node by the judgment unit in a tree form having a first direction in which the intermediate node image of the same layer is placed and a second direction indicating a depth direction of a layer of the intermediate node, based on the node information stored by the storage unit, and
a second placement unit that places a terminal node image of a node judged as the terminal node by the judgment unit at a position of the second direction from an intermediate node image of an upper intermediate node placed by the first placement unit and connected to an upper layer of the terminal node.

2. The configuration diagram preparing apparatus according to claim 1, wherein the second placement unit places, when one or more terminal node images of a plurality of terminal node images placed in the second direction from the intermediate node image are over a limit position of the second direction which is set for the configuration diagram, the one or more terminal node images in parallel to terminal node images other than the one or more terminal node images between the intermediate node image and the limit position.

3. The configuration diagram preparing apparatus according to claim 2, wherein:
the intermediate node image placed by the first placement unit is a rectangle having sides parallel to the first direction and the second direction, and
the first placement unit determines a width in the second direction of the intermediate node image based on the number of lower intermediate node images connected to a lower layer of the intermediate node image and a size of a connection port image depicted to correspond to each lower intermediate node image in the configuration diagram.

4. The configuration diagram preparing apparatus according to claim 3, wherein the first placement unit determines a width in the first direction of the intermediate node image based on the number of lower terminal node images connected to the lower layer of the intermediate node image, the number of arrays of the lower terminal node images, which are placed in parallel, and a size of a connection port image depicted to correspond to each lower terminal node image in the configuration diagram.

5. The configuration diagram preparing apparatus according to claim 4, wherein:
the terminal node image placed by the second placement unit is a rectangle having sides parallel to the first direction and the second direction, and
the second placement unit places all terminal node images in the configuration diagram as rectangles having the same shape and the same size.

6. The configuration diagram preparing apparatus according to claim 5, wherein:
the processing unit includes,
a first wiring unit that places a connection port image for each lower intermediate node image connected to the lower layer of the intermediate node image along one side of the intermediate node image parallel to the second direction, places a connection port image for the intermediate node image along one side of each lower intermediate node image parallel to the first direction, and performs wiring between the connection port image for each lower intermediate node image at the intermediate node image side and the connection port image for the intermediate node image at each lower intermediate node image side without crossing each other, in the configuration diagram.

7. The configuration diagram preparing apparatus according to claim 6, wherein:
the processing unit includes,
a second wiring unit that places a connection port image for each terminal node image connected to the intermediate node image along one side of the intermediate node image parallel to the first direction, places a connection port image for the intermediate node along one side on each terminal node image parallel to the second direction, and performs wiring between the connection port image for each terminal node image at the intermediate node side and the connection port image for the intermediate node at each terminal node image side without crossing each other, in the configuration diagram.

8. The configuration diagram preparing apparatus according to claim 6, wherein:
the processing unit includes,
a first additional writing unit that additionally writes information on a node corresponding to each intermediate node image and information on a port corresponding to each connection port image onto each intermediate node image and each connection port image associated with the intermediate node image in the configuration diagram, based on the node information stored by the storage unit.

9. The configuration diagram preparing apparatus according to claim 6, wherein:
the processing unit includes,
a second additional writing unit that additionally writes information on a node corresponding to each terminal node image and information on a port corresponding to each connection port image onto each terminal node image and each connection port image associated with the terminal node image in the configuration diagram, based on the node information stored by the storage unit.

10. The configuration diagram preparing apparatus according to claim 1, further comprising:
an output unit that outputs the configuration diagram prepared by the processing unit to a printing unit or a display unit in order to print the configuration diagram as one paper plane or display the configuration diagram as one screen.

11. A computer-readable recording medium storing a configuration diagram preparing program that makes a computer prepare a configuration diagram of a network having nodes including an intermediate node and a terminal node based on node information associated with each node in the network, the program instructing the computer to execute:
judging whether each node depicted as a node image in the configuration diagram is the intermediate node or the terminal node, based on the node information;
first placing, in the configuration diagram, an intermediate node image of a node judged as the intermediate node by the judging in a tree form having a first direction in which the intermediate node image of the same layer is placed and a second direction indicating a depth direction of a layer of the intermediate node, based on the node information; and
second placing a terminal node image of a node judged as the terminal node by the judgment unit at a position of the second direction from an intermediate node image of an upper intermediate node placed by the first placing and connected to an upper layer of the terminal node.

12. The computer-readable recording medium according to claim 11, wherein the program instructs the computer to execute:
in the second placing, placing, when one or more terminal node images of a plurality of terminal node images placed in the second direction from the intermediate node image are over a limit position of the second direction which is set for the configuration diagram, the one or more terminal node images in parallel to terminal node images other than the one or more terminal node images between the intermediate node image and the limit position.

13. The computer-readable recording medium according to claim 12, wherein:
the intermediate node image placed by the first placement unit is a rectangle having sides parallel to the first direction and the second direction, and
the program instructs the computer to execute:
in the first placing, determining a width in the second direction of the intermediate node image based on the number of lower intermediate node images connected to a lower layer of the intermediate node image and a size of a connection port image depicted to correspond to each lower intermediate node image in the configuration diagram.

14. The computer-readable recording medium according to claim 13, wherein the program instructs the computer to execute:
in the first placing, determining a width in the first direction of the intermediate node image based on the number of lower terminal node images connected to the lower layer of the intermediate node image, the number of arrays of the lower terminal node images, which are placed in parallel, and a size of a connection port image depicted to correspond to each lower terminal node image in the configuration diagram.

15. The computer-readable recording medium according to claim 14, wherein:
the terminal node image placed by the second placement unit is a rectangle having sides parallel to the first direction and the second direction, and
the program instructs the computer to execute:
in the second placing, placing all terminal node images in the configuration diagram as rectangles having the same shape and the same size.

16. The computer-readable recording medium according to claim 15, wherein the program instructs the computer to execute:
placing a connection port image for each node image connected to the lower layer on the intermediate node image along one side of the intermediate node image parallel to one direction,
placing a connection port image for the intermediate node image along one side of each node image parallel to the other direction, and
performing wiring between the connection port image for each node image at the intermediate node image side and the connection port image for the intermediate node image at each node image side without crossing each other, in the configuration diagram.

17. The computer-readable recording medium according to claim 16, wherein the program instructs the computer to execute:
additionally writing information on a node corresponding to each node image and information on a port corresponding to each connection port image onto each node image and each connection port image associated with the node image, in the configuration diagram, based on the node information.
